(19) United States
(12) Patent Application Publication
(10) Pub. No.: US 2015/0024701 A1
(43) Pub. Date: Jan. 22, 2015

(54) Mobile communication terminal, crime prevention method, computer-readable recording medium recording program thereon

(71) Applicant: Noriaki NAGASHIMA, Kanagawa (JP)

(72) Inventor: Noriaki NAGASHIMA, Kanagawa (JP)

(73) Assignee: NEC CASIO MOBILE COMMUNICATIONS, LTD., Kanagawa (JP)

(21) Appl. No.: 13/944,232

(22) Filed: Jul. 17, 2013

(51) Int. Cl. H04W 4/22

(52) U.S. Cl. CPC H04W 4/22
USPC 455/404.1

(57) ABSTRACT

When detecting occurrence of an emergency situation, a controller notifies a notification destination stored in a notification data storage of the occurrence via a wireless transmitter and receiver. An impact detector detects exertion of an impact. When the impact detector detects exertion of an impact equal to or higher than a threshold while the controller is transmitting notification to the notification destination, the controller allows a display to display a screen representing a state in which the notification is stopped, for example, an out-of-order screen.

### CROSS-REFERENCE TO RELATED APPLICATION

This application is based on Japanese Patent Application No. 2010-290109, filed on Dec. 27, 2010, and including specification, claims, drawings and summary. The disclosure of the above Japanese Patent Application is incorporated herein by reference in its entirety.

### FIELD

The present invention relate to a mobile communication terminal, a crime prevention method, and a computer-readable recording medium recording a program thereon.

### BACKGROUND

Mobile communication terminals including an alarm function for crime prevention are commercially available and are in common use. In response to a predetermined operation or the like, mobile communication terminals of this kind output an alarm to let surrounding people know the occurrence of an emergency situation. Mobile communication terminals are also available which allow pre-registered persons to be automatically notified of the occurrence of an emergency situation by e-mail or telephone.

A person who attempts to inflict harm on a user (hereinafter referred to as a perpetrator) is likely to stop the alarm. Unexamined Japanese Patent Application Kokai Publication No. 2006-270727 and Unexamined Japanese Patent Application Kokai Publication No. 2008-172451 disclose mobile communication terminals that continue a notification process (automatic notification process) even if the perpetrator stops the alarm.

The mobile communication terminal disclosed in Unexamined Japanese Patent Application Kokai Publication No. 2006-270727 continues an automatic notification process even if a power supply is turned off during the automatic notification process. During an alarm operation, the mobile communication terminal avoids indicating that the terminal is performing a transmission operation. When the power supply is turned off during the transmission operation, the mobile communication terminal stops the display but continues the transmission operation.

Furthermore, the mobile communication terminal disclosed in Unexamined Japanese Patent Application Kokai Publication No. 2008-172451 includes a main body and a crime prevention key. One of the mobile communication terminal main body and the crime prevention key outputs an alarm, whereas the other performs automatic notification.

However, neither of the mobile communication terminals described in the respective documents is able to perform alarming or automatic notification if the perpetrator destroys the device that is performing the automatic notification.

Furthermore, the mobile communication terminal operates using a removable battery as a power supply. Thus, removal of the battery precludes the mobile communication terminal from operating.

### SUMMARY

In view of the above-described circumstances, it is an exemplary object of the present invention to provide a mobile terminal that includes an alarm function for crime prevention and that is unlikely to be destroyed.

It is another exemplary object of the present invention to provide a mobile terminal that usefully ensures the safety of a holder of the mobile terminal.

To achieve the exemplary objects, a mobile communication terminal according to a first exemplary aspect of the present invention includes:

a notifier that transmits notification to a preset notification destination;

an impact detector that detects an impact exerted on the mobile communication terminal;

a display; and

a controller that displays, on the display, a screen representing a state in which the notification by the notifier is stopped when the impact detector detects an impact while the notifier is transmitting notification to the notification destination.

The controller, for example, causes the display to display a screen substantially identical to a screen displayed when the mobile communication terminal is faulty, when the impact detector detects an impact.

The mobile communication terminal is allowed to further include a state storage that stores state data indicating whether or not the mobile communication terminal is in a state in which the notifier is transmitting the notification. When the mobile communication terminal is powered on, the notifier starts transmitting the notification to the notification destination if the data indicating that the mobile communication terminal is in a state in which the notifier is transmitting the notification is stored in the state storage.

The controller, for example, causes the notifier to start transmitting the notification to the notification destination when the impact detector detects the impact or when a predetermined operation is performed.

The mobile communication terminal is allowed to include, for example, an alarm that outputs an alarm. In this case, the controller, for example, causes the alarm to output an alarm and causes the notifier to transmit the notification, when detecting a predetermined operation or when the impact detector detects the impact in a power-off state in which the mobile communication terminal is powered off or in a normal operating state in which the mobile communication terminal is operating normally, and causes the alarm to stop the alarm, causes the display to display an image indicating that the mobile communication terminal is faulty, and causes the notifier to continue the notification when the impact detector detects the impact while the alarm is outputting the alarm.

The controller, for example, causes the notifier to start the notification and prevents the display from indicating that the notification is being transmitted to shift the mobile communication terminal to a pseudo normal operating state when the impact detector detects the impact while the mobile communication terminal is in normal operating state in which the mobile communication terminal is operating normally.

The controller, for example, causes the display to be turned off and causes the notifier to continue the notification to shift the mobile communication terminal to a pseudo power-off state in which the mobile communication terminal is apparently powered off with the notification continued, when detecting a power-off operation while the mobile communication terminal is in the pseudo normal operating state.

The controller, for example, causes the alarm to output an alarm and causes the notifier to continue the notification to shift the mobile communication terminal to an alarm output state when detecting execution of a predetermined operation while the mobile communication terminal is in the pseudo normal operating state.

The controller, for example, causes the notifier to continue the notification and causes the display to display an image indicating that the mobile communication terminal is faulty to shift the mobile communication terminal to a pseudo malfunction state when the impact detector detects the impact while the mobile communication terminal is in the pseudo normal operating state.

The controller, for example, causes the notifier to start the notification with the display keeping turned off to shift the mobile communication terminal to the pseudo power-off state when the impact detector detects the impact or when execution of a predetermined operation indicating occurrence of an emergency situation is detected while the mobile communication terminal is in the power-off state.

The controller, for example, causes the display to display an image identical to an image displayed in a normal state and causes the notifier to continue the notification to shift the mobile communication terminal to the pseudo normal operating state when a power-on operation is performed while the mobile communication terminal is in the pseudo power-off state.

The controller, for example, causes the notifier to stop the notification to shift the mobile communication terminal to the power-off state when detecting execution of an operation of giving an instruction to stop the notification while the mobile communication terminal is in the pseudo power-off state.

The controller, for example, causes the display to turn off the display and causes the notifier to continue the notification to shift the mobile communication terminal to the pseudo power-off state in which the mobile communication terminal is apparently powered off, when detecting execution of an operation of turning off the mobile communication terminal in the alarm output state in which the alarm outputs the alarm, with the notifier transmitting the notification.

The controller, for example, causes the alarm to stop the alarm and causes the notifier to stop the notification to shift the mobile communication terminal to the normal operating state when a predetermined first operation is performed to stop the alarm while the alarm is outputting the alarm, and causes the alarm to stop the alarm, causes the notifier to continue the notification, and prevents the display from presenting that the notification is being transmitted to shift the mobile communication terminal to the pseudo normal operating state when a second operation different from the first operation is performed while the alarm is outputting the alarm.

The controller, for example, causes the alarm to stop the alarm, causes the display to provide a display equivalent to a display provided when a power supply voltage decreases below a reference level, and causes the notifier to continue the notification to shift the mobile communication terminal to a pseudo low voltage state when the alarm continues to output the alarm for a specific period.

The controller, for example, causes the display to display an image showing a fault and causes the notifier to continue the notification to shift the mobile communication terminal to the pseudo malfunction state when the impact detector detects an impact during the pseudo low voltage state or when the impact detector detects the impact during the alarm output state.

The mobile communication terminal is allowed to include a power supply device that supplies an operating power to the notifier, the display, and the controller. The power supply device, for example, includes a removable battery and an unremovable electric energy retaining device.

To achieve the exemplary objects, a crime prevention method according to an exemplary aspect of the present invention includes:

a notification step of transmitting notification to a preset notification destination;

an impact detection step of detecting an impact exerted on the mobile communication terminal; and

a step of displaying a screen indicating that the notification is stopped with the notification in the notification step maintained when exertion of an impact is detected in the impact detection step during the notification in the notification step.

To achieve the exemplary objects, a computer-readable recording medium is provided which including a crime prevention program recorded thereon according to an exemplary aspect of the present invention, the program causing a computer to execute:

a notification step of transmitting notification to a preset notification destination;

an impact detection step of detecting an impact exerted on the mobile communication terminal; and

a step of displaying a screen indicating that the notification is stopped with the notification in the notification step maintained when exertion of an impact is detected in the impact detection step during the notification in the notification step.

According to the present invention, if a perpetrator attempts to destroy the mobile communication terminal, the automatic notification function is apparently stopped to suppress a further act of destruction, while the automatic notification is allowed to be continued.

### BRIEF DESCRIPTION OF THE DRAWINGS

A more complete understanding of this application can be obtained when the following detailed description is considered in conjunction with the following drawings, in which:

FIG. 1 is a block diagram of a mobile communication terminal according to Exemplary Embodiment 1;

FIG. 2 is a block diagram of a network system including the mobile communication terminal;

FIG. 3 is a diagram depicting an example of an e-mail transmitted by automatic notification;

FIG. 4 is a diagram depicting a state transition of the mobile communication terminal;

FIG. 5 is a diagram depicting an example of a menu screen in a normal operating state of the mobile communication terminal;

FIG. 6 is a diagram depicting an example of an alarm-in-action screen displayed when the mobile communication terminal is in an alarm output state;

FIG. 7A to FIG. 7D are diagrams depicting an example of an out-of-order screen displayed when the mobile communication terminal is in a background notification state, that is, a screen equivalent to a screen displayed when the mobile communication terminal is faulty;

FIG. 8A is a flowchart of an alarm and notification process carried out by the mobile communication terminal;

FIG. 8B is a flowchart of an impact and stop operation monitoring process carried out by the mobile communication terminal;

FIG. 9 is a flowchart depicting operation of the mobile communication terminal performed when the mobile communication terminal is provided with a battery and then started;

FIG. 10 is a block diagram depicting a configuration of a mobile communication terminal according to Exemplary Embodiment 2;

FIG. 11 is a diagram depicting a state transition of the mobile communication terminal according to Exemplary Embodiment 2;

FIG. 12 is a diagram depicting an example of a state transition table stored in the mobile communication terminal according to Exemplary Embodiment 2;

FIG. 13 is a flowchart depicting operation of the mobile communication terminal according to Exemplary Embodiment 2 performed when the mobile communication terminal is provided with a battery and then started;

FIG. 14 is a block diagram of a power supply device with an auxiliary battery; and

FIG. 15 is a block diagram of a mobile communication terminal according to Exemplary Embodiment 3.

### EXEMPLARY EMBODIMENT

Exemplary embodiments will be described below in detail with reference to the drawings.

### Exemplary Embodiment 1

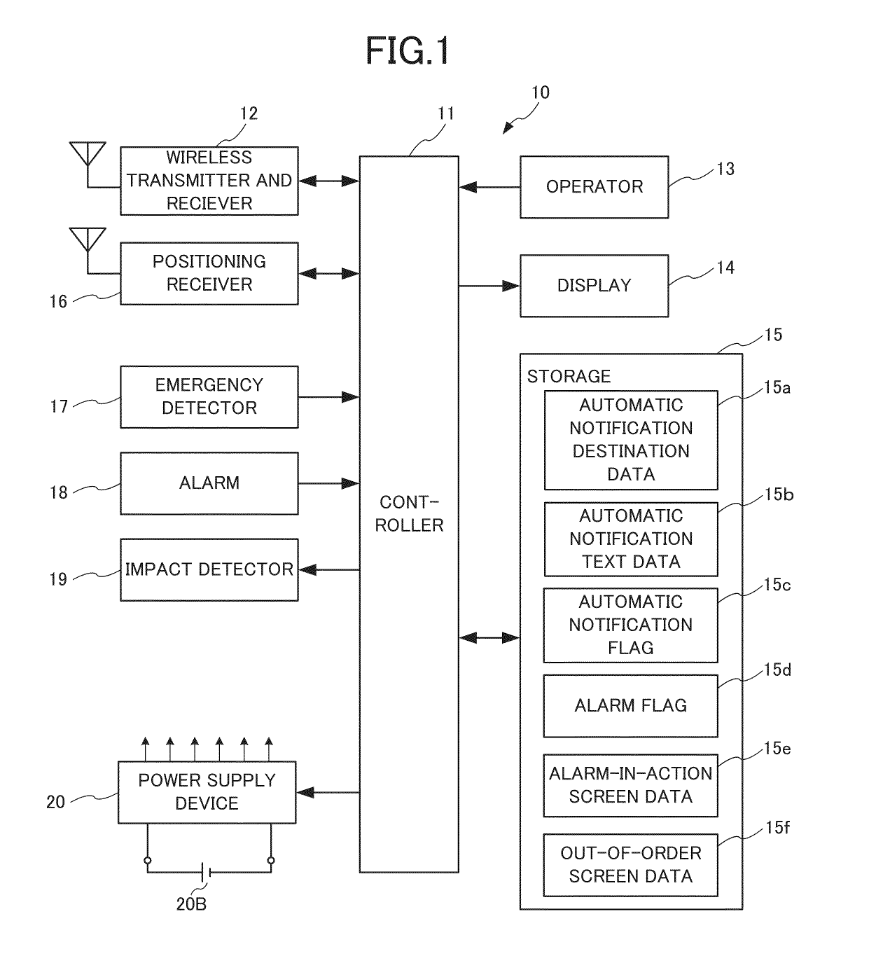

As depicted in FIG. 1, a mobile communication terminal 10 according to Exemplary Embodiment 1 includes a controller 11, a wireless transmitter and receiver 12, an operator 13, a display 14, a storage 15, a positioning information receiver 16, an emergency detector 17, an alarm 18, an impact detector 19, and a power supply device 20.

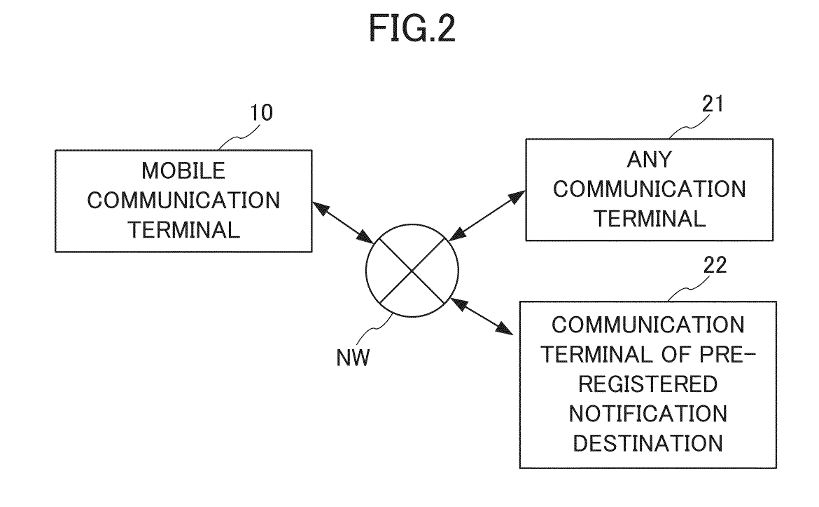

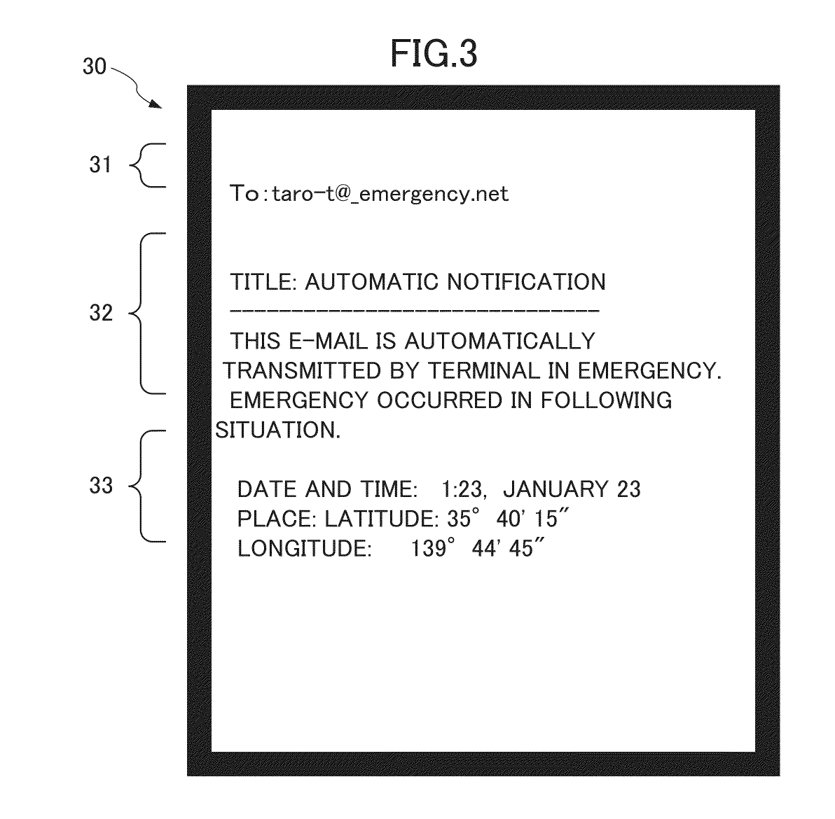

The controller 11 includes a CPU (Central Processing Unit) and a RAM (Random Access Memory). The controller 11 executes a program read from the storage 15 and transmits and receives signals to and from components of the mobile communication terminal 10 to control the components of the mobile communication terminal 10, allowing the mobile communication terminal to function as a mobile information processing terminal. For example, as depicted in FIG. 2, the controller 11 communicates with other communication terminals 21 and 22 via the wireless transmitter and receiver 12 and a mobile communication network NW (telephone calls or transmission and reception of e-mails). Furthermore, when an emergency situation occurs, the controller 11 controls the alarm 18 so that the alarm 18 outputs an alarm and transmits an emergency notification mail in a preset format as illustrated in FIG. 3 to a preset destination 22 via the wireless transmitter and receiver 12 (automatic notification). Operation of the controller 11 will be described below in detail. The controller 11 includes a clocking function to acquire the current time.

The wireless transmitter and receiver 12 includes an antenna and functions to connect the mobile communication terminal 10 to the mobile communication network NW.

The operator 13 includes input keys and pointing device. The operator 13 receives inputs from a user to the mobile communication terminal 10 such as instructions, and notifies the controller 11 of operation signals. The instructions and the like input by the user include a power-on operation, a power-off operation, mode switching between browsing and edition of e-mails, and input of contents of an e-mail.

The display 14 includes an LCD (Liquid Crystal Display). The display 14 displays the contents of communication and information for the user's input under the control of the controller 11.

The storage 15 includes a nonvolatile semiconductor memory such as a flash memory, and stores data needed for the operation of the mobile communication terminal 10 such as programs executed by the controller 11 and an address book. The storage 15 also stores automatic notification destination data 15a, automatic notification text data 15b, an automatic notification flag 15c, an alarm flag 15d, alarm-in-action screen data 15e, and out-of-order screen data 15f.

The automatic notification destination data 15a is the destination address of an emergency notification mail automatically transmitted by the controller 11 and corresponds to a destination address 31 of an emergency notification mail 30 illustrated in FIG. 3. The automatic notification destination data 15a is, for example, a plurality of destination addresses. The automatic notification destination data 15a is allowed to be, for example, the mail address of a notification reception center.

The automatic notification text data 15b specifies fixed phrases to be described in the emergency notification mail and corresponds to a text 32 of the emergency notification mail 30 illustrated in FIG. 3. For the automatic notification destination data 15a and the automatic notification text data 15b, default data is allowed to be set, for example, before shipment of the mobile communication terminal 10. A user is able to edit the automatic notification destination data 15a and the automatic notification text data 15b via the operator 13 and the controller 11.

The automatic notification flag 15c is status information indicating that the mobile communication terminal is ready for automatic notification. The automatic notification flag 15c is set by the controller 11 when the emergency detector 17 detects occurrence of an emergency situation and when the impact detector 19 detects a strong impact equal to or higher than a threshold.

The alarm flag 15d is information indicating that the alarm is being output.

The alarm-in-action screen data 15e is data defining an image to be displayed on the display 14 while the mobile communication terminal 10 is outputting the alarm. The alarm image data 15e includes, for example, data defining an image indicating that the alarm is being output as a result of the occurrence of an emergency situation.

The out-of-order screen data 15f defines an image to be displayed on the display 14 in order to mimic a fault in the mobile communication terminal 10. The out-of-order screen data 15f includes data defining an image of a nonsensical fragmentary character string.

The positioning information receiver 16 includes an antenna and a GPS (Global Positioning System) module. The positioning information receiver 16 uses the functions of the GPS module to acquire positioning information indicative of the current position of the mobile communication terminal 10 and to supply the positioning information to the controller 11.

The emergency detector 17 detects that a user of the mobile communication terminal 10 is involved in an emergency situation. The emergency detector 17 includes a pull tab and a detector detecting installation and removal of the pull tab, and detects the occurrence of an emergency situation based on pullout of the pull tab and notifies the controller 11 of the occurrence of the emergency situation.

The alarm 18 includes a light and a speaker, and outputs the alarm based on light emission or a buzzer sound under the control of the controller 11.

The impact detector 19 includes an acceleration sensor and an impact sensor, and detects exertion, on the mobile communication terminal 10, of an impact that is equal to or higher than a threshold and that is not made during normal use and notifies the controller 11 of the exertion of the impact. The threshold is, for example, set for the impact detector 19, for example, before shipment.

The power supply device 20 includes a removable battery 20B, and uses energy stored in the battery 20B to control the supply of power to the components and the stoppage of the supply and voltages applied to the respective components under the control of the controller 11 in accordance with the operating state of the mobile communication terminal 10.

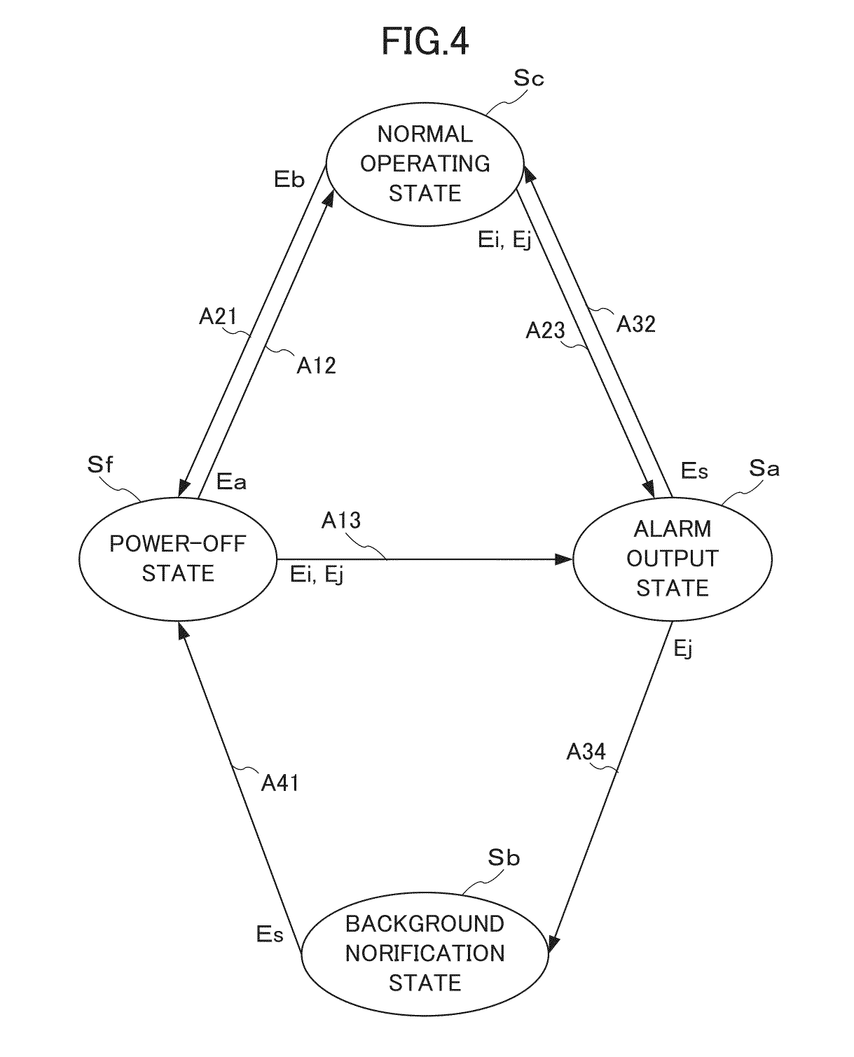

Now, the operation of the mobile communication terminal 10 will be described with reference to a state transition diagram depicted in FIG. 4.

The mobile communication terminal 10 assumes four states, that is, a power-off state Sf, a normal operating state Sc, an alarm output state Sa, and a background notification state Sb. When a predetermined event described below occurs, the mobile communication terminal 10 change the state among such four states and operates according to the state among the four states.

The power-off state Sf is a state in which the mobile communication terminal 10 is powered off. Even in the power-off state Sf, the power supply device 20 supplies power to the controller 11, the wireless transmitter and receiver 12, the emergency detector 17, the impact detector 19, and the like, and the mobile communication terminal 10 operates in a power saving mode (sleep mode or power saving mode). Thus, an operation of turning on the power supply is effective.

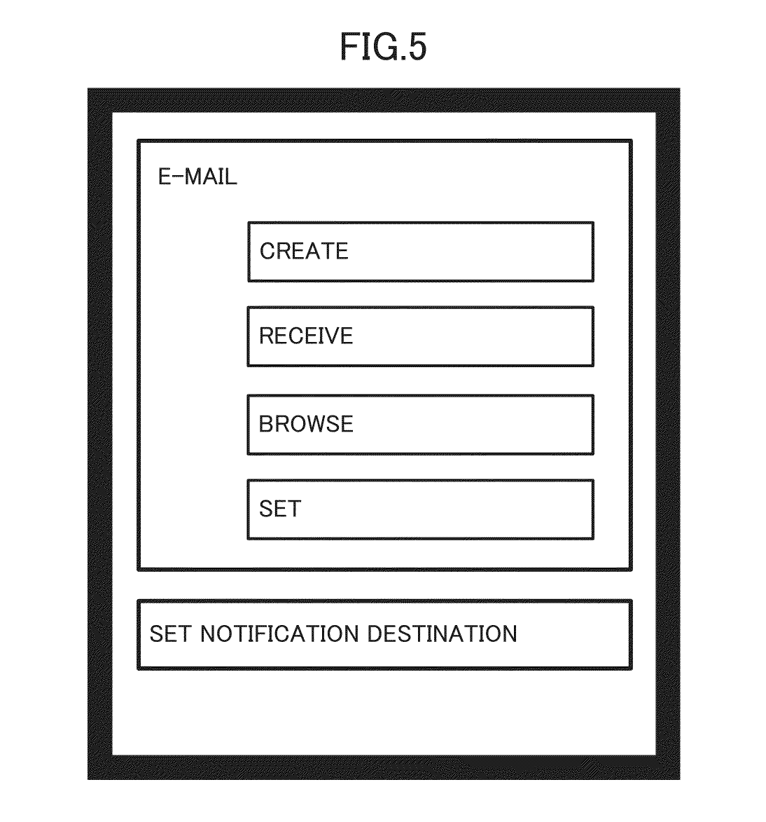

The normal operating state Sc is a state in which the mobile communication terminal 10 is powered on and operates normally. When the mobile communication terminal 10 is in the normal operating state Sc, the user is allowed to use the mobile communication terminal 10 for common applications, for example, for telephone calls or transmission of e-mails. For example, when the user processes an e-mail, the display 14 displays such an electronic mail operation screen as depicted in FIG. 5. The user performs operations with reference to a screen (menu) displayed on the display 14 to allow the mobile communication terminal 10 to carry out a desired process such as creation or reception of an e-mail. In the exemplary screen in FIG. 5, “Set notification destination” enables the automatic notification destination data 15a stored in the storage 15 to be edited.

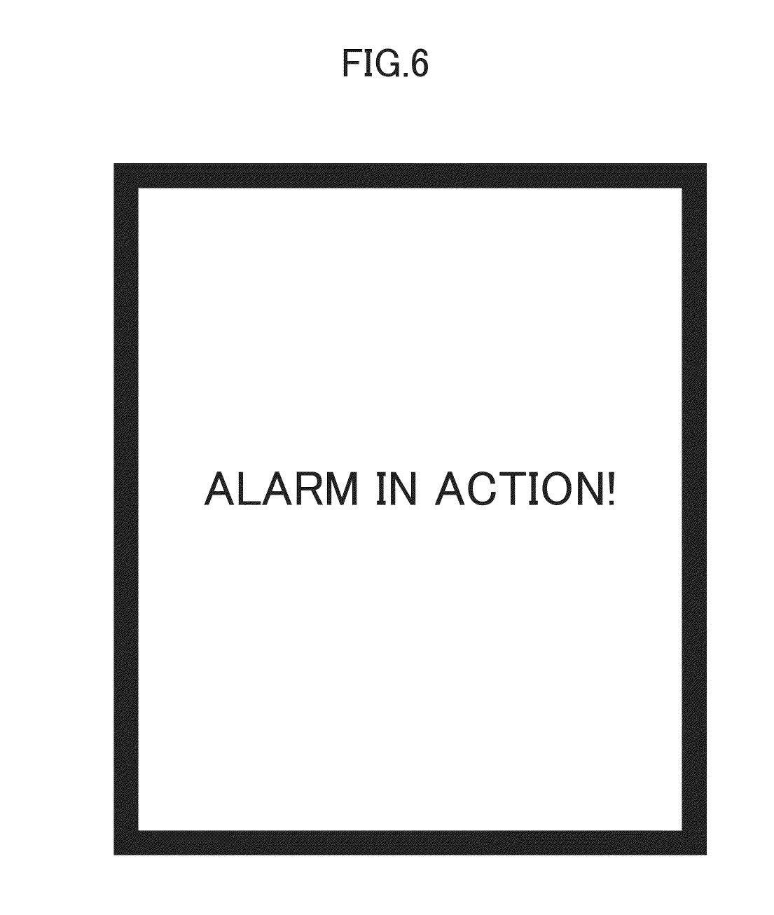

Referring back to FIG. 4, in the alarm output state Sa, the mobile communication terminal 10 controls the alarm 18 so that the alarm 18 outputs the alarm, and periodically transmits the automatic notification mail illustrated in FIG. 3. In the alarm output state Sa, the mobile communication terminal 10 displays, on the display 14, an image specified by the alarm-in-action screen data 15e, for example, an image depicted in FIG. 6.

In the background notification state (fault mimicking state) Sb depicted in FIG. 4, the mobile communication terminal 10 periodically transmits automatic notification mail while mimicking a fault. In the background notification state Sb, the mobile communication terminal 10 stops the alarm and displays, on the display 14, such an image as displayed when the mobile communication terminal 10 is faulty as specified by the out-of-order screen data 15f.

While the mobile communication terminal 10 is in the power-off state Sf, the controller 11, when detecting a power-on operation performed via the operator 13 (the occurrence of an event “detection Ea of a power-on operation”), shifts the operating state of the mobile communication terminal 10 to the normal operating state Sc as depicted by arrow A12.

While the mobile communication terminal 10 is in the normal operating state Sc, the controller 11, when detecting a power-off operation performed via the operator 13 (the occurrence of an event “detection Eb of a power-off operation”), shifts the operating state of the mobile communication terminal 10 to the power-off state Sf as depicted by arrow A21.

While the mobile communication terminal 10 is in the power-off state Sf, when the emergency detector 17 detects “pullout of the pull tab” (the occurrence of an event “detection Ei of an emergency situation”) or the impact detector 19 detects an “impact equal to or higher than the threshold” (the occurrence of an event “detection Ej of an impact”), the controller 11 shifts the mobile communication terminal 10 to the alarm output state Sa as depicted by arrow A13. As a result of this state transition, the controller 11 allows the alarm 18 to start the alarm and starts an automatic notification process. Furthermore, the controller 11 sets the automatic notification flag 15c and the alarm flag 15d on, to allow the display 14 to display the alarm-in-action screen data 15e.

Similarly, while the mobile communication terminal 10 is in the normal operating state Sc, when the event “detection Ei of an emergency situation” or “detection Ej of an impact” occurs, the controller 11 shifts the mobile communication terminal 10 to the alarm output state Sa as depicted by arrow A23. As a result of this state transition, the alarm 18 starts generating an alarm, and the controller 11 starts an automatic notification process. The controller 11 further sets the automatic notification flag 15c and the alarm flag 15d on to allow the display 14 to display the alarm-in-action screen data 15e.

While the mobile communication terminal 10 is in the alarm output state Sa, when the event “detection Ej of an impact” occurs, the controller 11 shifts the mobile communication terminal 10 to the background notification state Sb as depicted by arrow A34. As a result of this state transition, the controller 11 allows the alarm 18 to stop the alarm, sets the alarm flag 15d off, allows the display 14 to display the out-of-order screen data 15f, and continues the automatic notification process. The out-of-order screen data 15f is an example of a screen mimicking a state in which the mobile communication terminal 10 has stopped the automatic notification (is not transmitting notification).

While the mobile communication terminal 10 is in the alarm output state Sa, the controller 11, when detecting that an operation of stopping the automatic notification has been performed through the operator 13a (the occurrence of an event “detection Es of a notification stop operation), shifts the mobile communication terminal 10 to the normal operating state Sc as depicted by arrow A32. As a result of this state transition, the controller 11 allows the alarm 18 to stop the alarm, stops the automatic notification, and sets the automatic notification flag 15c and the alarm flag 15d off.

The notification stop operation as used herein refers to execution of a preset process, for example, a process in which the user inputs a personal identification number through the operator 13 or transmits an e-mail including a predetermined content from a predetermined address to the mobile communication terminal 10. A person other than the user, particularly the perpetrator does not know the contents of the notification stop operation, and thus, fails to stop the alarm or the automatic notification by the notification stop operation.

While the mobile communication terminal 10 is in the background notification state Sb, when the event “detection Es of a notification stop operation” occurs, the controller 11 shifts the mobile communication terminal 10 to the power-off state Sf and sets the automatic notification flag 15c off to stop the automatic notification, as depicted by arrow A41.

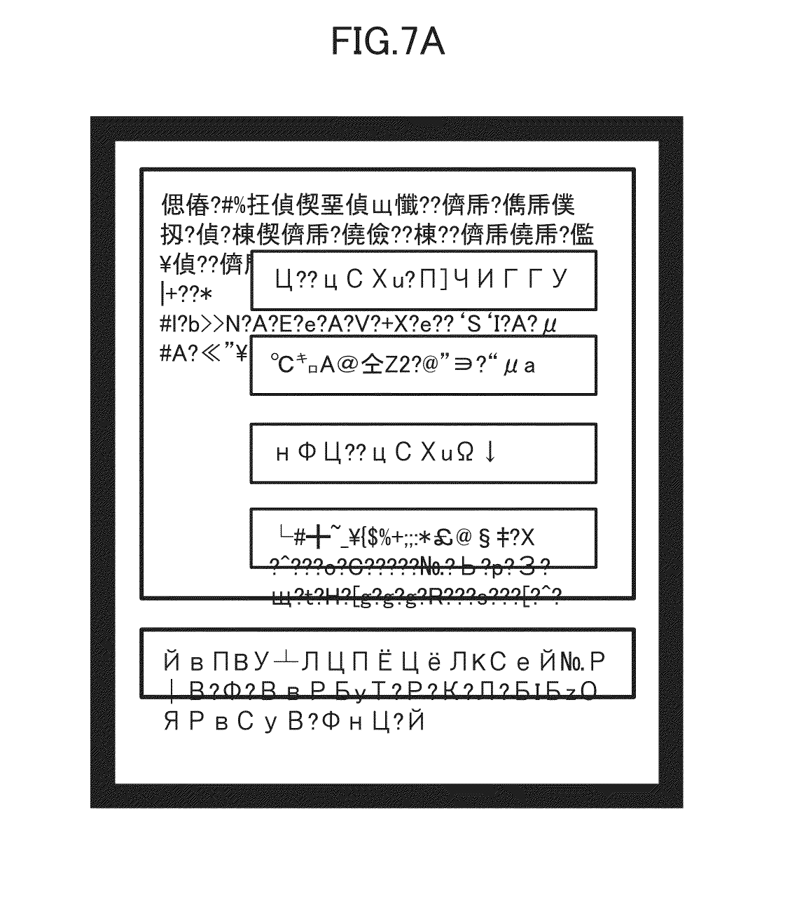

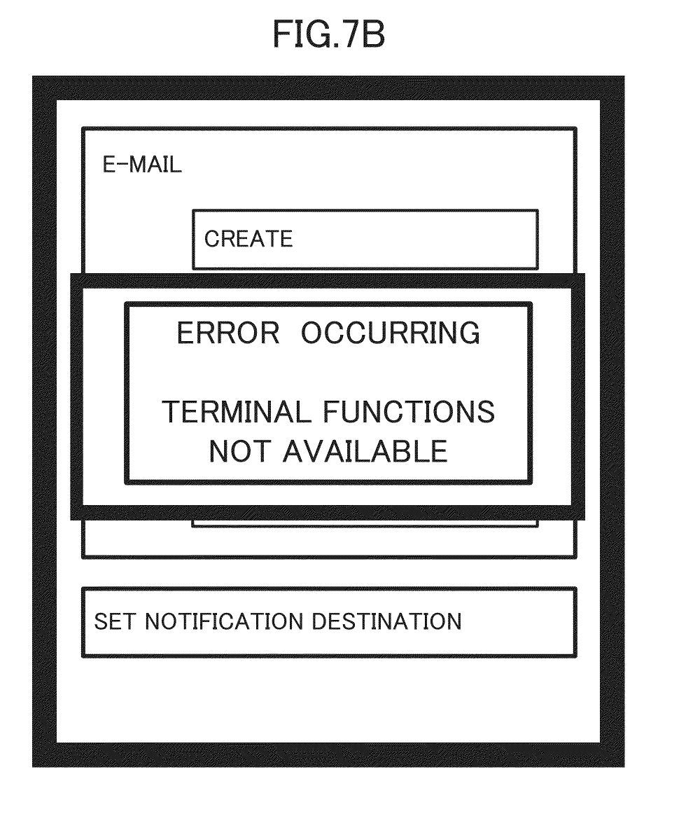

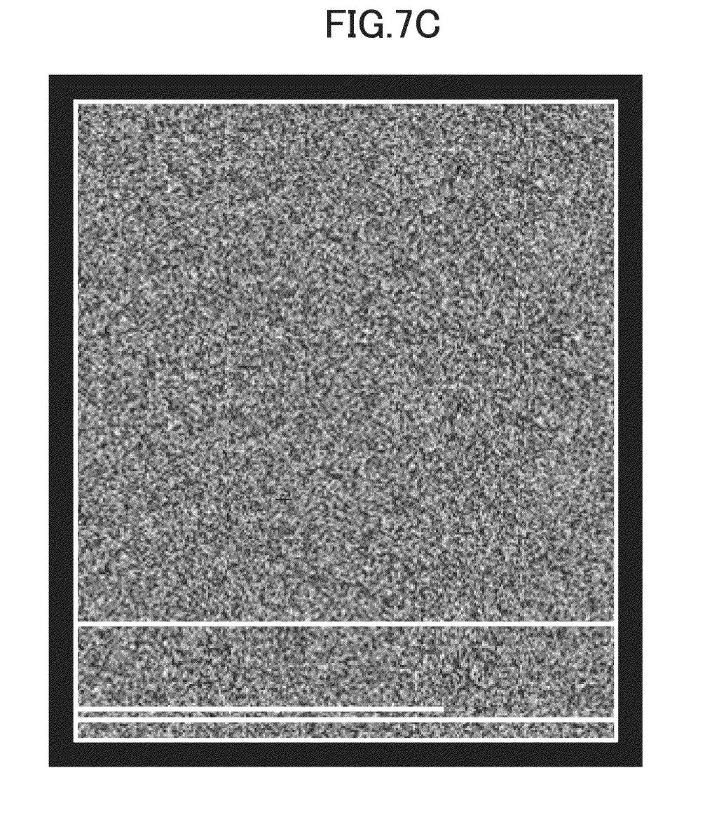

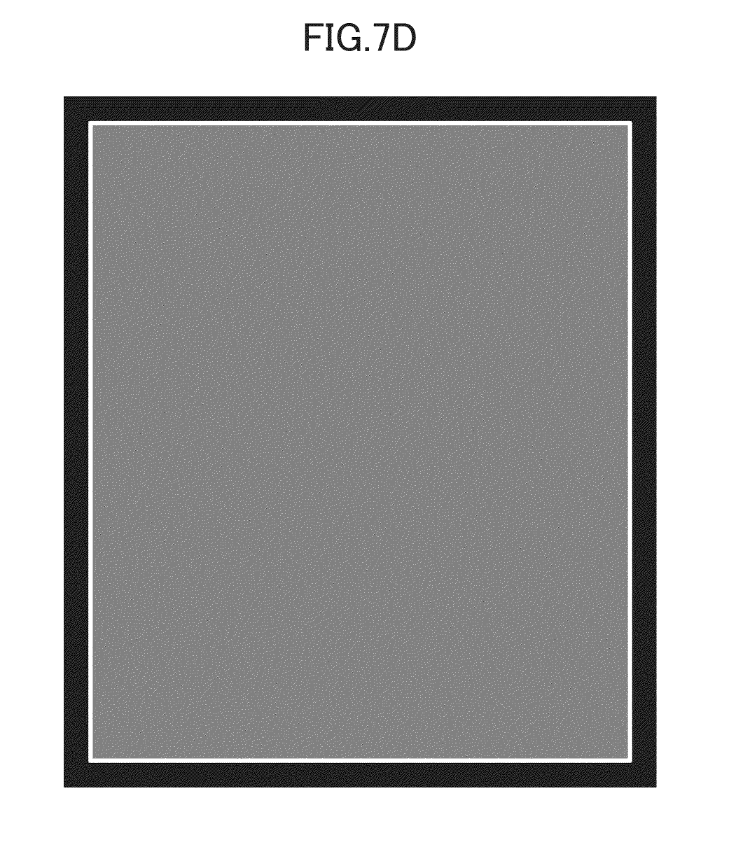

While the mobile communication terminal 10 is in the background notification state Sb, the display 14 displays a mimic screen to make the perpetrator think that the automatic notification function has stopped as described above. The mimic screen displayed by the display 14 is, for example, a display of a nonsensical character string as depicted in FIG. 7A or a display of a message explicitly indicating that the mobile communication terminal 10 is faulty as depicted in FIG. 7B. Alternatively, the screen is allowed to display a noise screen as depicted in FIG. 7C or a screen with all display operations stopped as depicted in FIG. 7D.

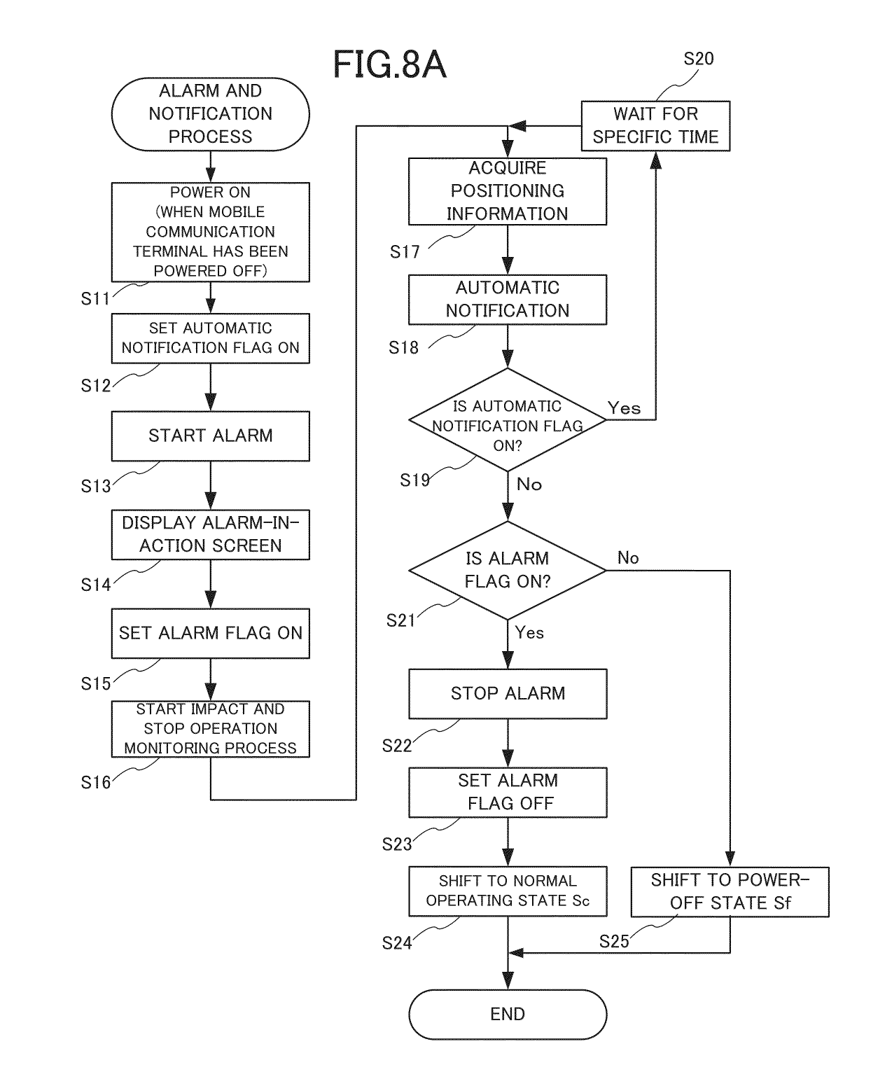

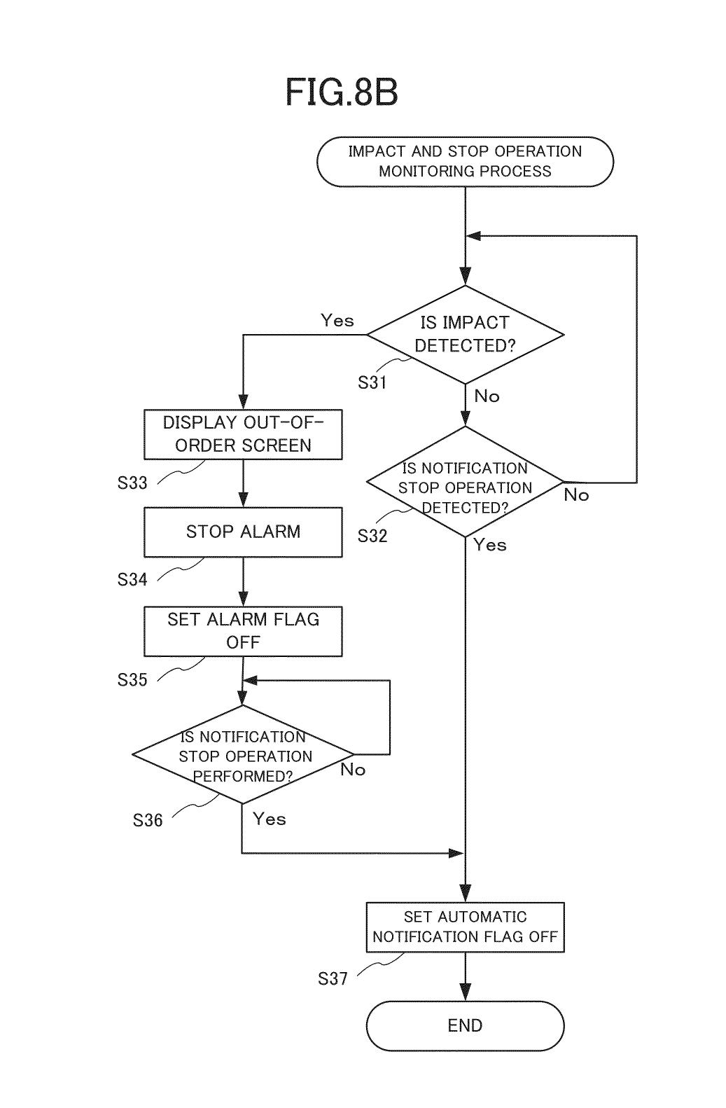

Now, characteristic operations of the mobile communication terminal 10 in the alarm output state Sa and the background notification state Sb will be described in detail with reference to FIG. 8A and FIG. 8B.

First, in the power-off state Sf or the normal operating state Sc, when the user pulls the pull tab on the emergency detector 17, the emergency detector 17 detects the occurrence of an emergency situation and notifies the controller 11 of the occurrence (occurrence of the event Ei). Furthermore, in the power-off state Sf or the normal operating state Sc, when a strong impact is exerted on the mobile communication terminal 10, the impact detector 19 detects the impact, which is equal to or higher than the threshold, and notifies the controller 11 of the impact (occurrence of the event Ej).

In response to the notification, the controller 11 starts the alarm and notification process depicted in FIG. 8A. First, the controller 11 powers on when the mobile communication terminal 10 is in the power-off state Sf. That is, the controller 11 controls the power supply device 20 so that the power supply device 20 supplies an operating voltage to each of the components (step S11).

Then, the controller 11 sets the automatic notification flag 15c on (step S12). The controller 11 subsequently controls the alarm 18 to start the alarm (step S13). The alarm 18 starts the alarm by, for example, outputting a beep sound or emitting flash light.

The controller 11 subsequently reads the alarm-in-action screen data 15e and allows the display 14 to display the read alarm-in-action screen data 15e as depicted in FIG. 6 (step S14).

The controller 11 subsequently sets the alarm flag 15d on (step S15).

The controller 11 subsequently initiates an impact and stop operation monitoring process depicted in FIG. 8B (step S16). The impact and stop operation monitoring process will be described below.

The controller 11 subsequently acquires information on the current position (positioning information: latitude and longitude) from a GPS signal received by the positioning information receiver 16 (step S17).

Subsequently, based on the automatic notification destination data 15a and automatic notification text data 15b stored in the storage 15, the positioning information acquired in step S17, and the current date and time clocked by the controller 11, the controller 11 creates and transmits the automatic notification mail illustrated in FIG. 3 (step S18).

The controller 11 subsequently determines whether or not the automatic notification flag 15c is on (step S19).

If the automatic notification flag 15c is on, that is, if the automatic notification is to be continued (step S19; Yes), the mobile communication terminal 10 waits for a specific time (step S20) and returns to step S17. Thus, an e-mail containing the position, the time, and a predetermined message continues to be periodically transmitted to the destination specified by the automatic notification destination data 15a until the automatic notification flag 15c is set off.

On the other hand, in step S19, when determining that the automatic notification flag 15c is off (step S19; No), the controller 11 determines whether or not the alarm flag 15d is on (step S21).

If the alarm flag 15d is on, that is, the mobile communication terminal 10 is in the alarm output state Sa (step S21; Yes), the controller 11 controls the alarm 18 to stop the alarm (step S22), sets the alarm flag off (step S23), shifts the operating state to the normal operating state Sc (step S24), and ends the process. The controller 11 thereafter performs an operation for the normal operating state Sc.

On the other hand, if the alarm flag is off (step S21; No), the controller 11 controls each of the components to shift the operating state to the power-off state Sf (step S25). The controller 11 thereafter performs an operation for the power-off state Sf.

On the other hand, when setting the alarm flag 15d in step S15, the controller 11 starts an impact and stop operation monitoring process depicted in FIG. 8B in parallel with the alarm and notification process.

The impact monitoring process is carried out when detecting that the mobile communication terminal 10 is subjected to such a strong impact as destroys the mobile communication terminal 10 in the alarm output state Sa.

First, the controller 11 determines whether or not the impact detector 19 has detected an impact equal to or higher than the threshold, that is, the event Ej has occurred (step S31).

If no strong impact has been detected (step S31; No), the controller 11 determines whether or not a notification stop operation for stopping the automatic notification has been detected (step S32). If the notification stop operation has not been detected (step S32; No), the flow returns to step S31. Thus, the controller 11 repeats steps S31 and S32.

On the other hand, in the alarm output state Sa, if the alarm detector 19 detects a strong impact equal to or higher than the threshold (step S31; Yes), the controller 11 reads the out-of-order screen data 15f from the storage 15 and allows the display 14 to display the out-of-order screen data 15f instead of the current display (step S33). Subsequently, the controller 11 controls the alarm 18 to stop the alarm (step S34). The controller 11 subsequently sets the alarm flag 15d off stored in the storage 15 (step S34). If the mobile communication terminal 10 has other functions, for example, a telephone function and a web connection function, these functions are allowed to be set to an inactive state.

Thus, the mobile communication terminal 10 shifts the alarm output state Sa to the background notification state Sb, avoids outputting the alarm, and displays an out-of-order image depicted in FIG. 7A to FIG. 7D on the display 14. Hence, the perpetrator falsely recognizes that the mobile communication terminal 10 is faulty and stops a further act of destruction. However, the controller 11 carries out the processing in steps S17 to S20 in FIG. 8A to continue to periodically communicate an e-mail containing information such as the occurrence of an emergency situation, the current position, and the current time to the destination indicated by the automatic notification destination data 15a.

The controller 11 subsequently waits to detect a notification stop operation performed by the user (FIG. 8B, step S36). That is, the mobile communication terminal 10 continues the automatic notification, while pretending to be faulty.

When detecting a notification stop operation performed by the user in step S32 or S36 (step S32 or step S36; Yes), the controller 11 sets the automatic notification flag 15c off (step S37) to end the process. The automatic notification flag 15c which has been set off is determined in step S19 in FIG. 8A.

With the above-described process, when, for example, the user pulls the pull tag on the emergency detector 17 in an emergency situation or the impact detector 19 detects a strong impact exerted by the perpetrator, the controller 11 starts the alarm and notification process. Thus, the mobile communication terminal 10 outputs the alarm and transmits an e-mail describing the current position, the current time, and the like to the preset destination. At this time, the display 14 displays a screen defined by the alarm-in-action screen data 15e and representing the alarm output state as illustrated in FIG. 4.

When the perpetrator exerts a strong impact on the mobile communication terminal 10 in order to destroy the mobile communication terminal 10, the impact detector 19 detects the impact, and the controller 11 stops the alarm and displays such an out-of-order image as illustrated in FIG. 7A to FIG. 7D on the display 14. Thus, the perpetrator falsely recognizes that the mobile communication terminal 10 is faulty, and is unlikely to conduct a further act of destruction. On the other hand, the mobile communication terminal 10 continues the automatic notification, thus contributing to the user's safety.

Even when such a configuration is adopted, if the battery 20B is removed, the mobile communication terminal 10 stops operating. However, when the battery 20B is loaded in the mobile communication terminal 10 again, the mobile communication terminal 10 starts the operation in the background notification state Sb.

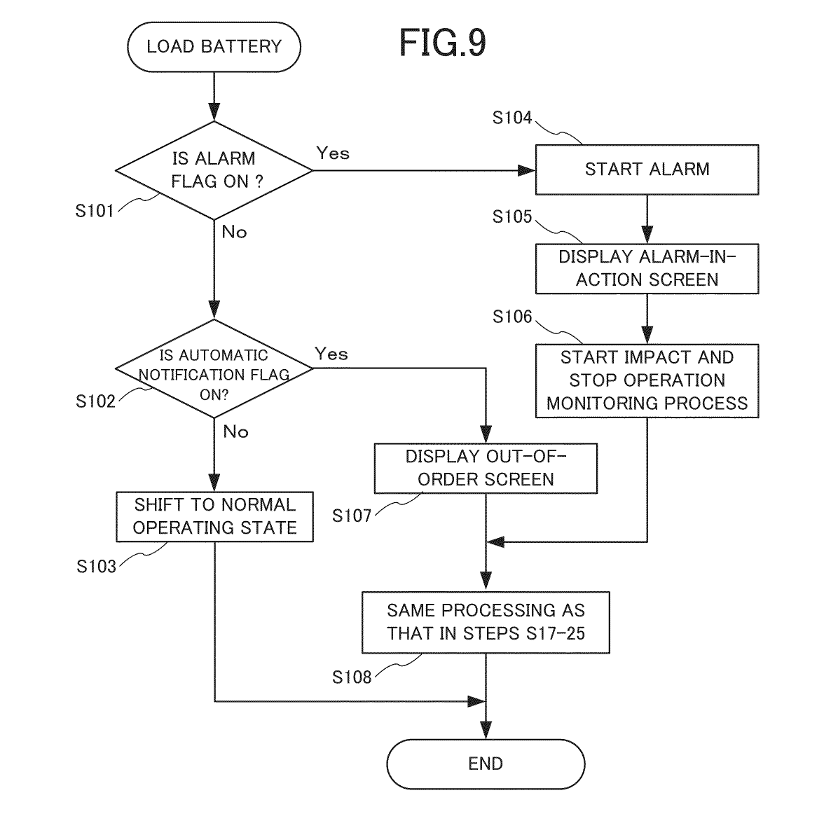

Now, the operation of the mobile communication terminal 10 provided with the battery 20B again will be described with reference to FIG. 9.

When the battery 20B is loaded in the mobile communication terminal 10, the controller 11 starts a battery loading process depicted in FIG. 9 after an initialization process. First, the controller 11 determines whether or not the alarm flag 15d is on (step S101). When determining that the alarm flag 15d is off (step S101; No), the controller 11 determines whether or not the automatic notification flag 15c is on (step S102). When determining that the automatic notification flag 15c is off (step S102; No), the controller 11 continues the process in the normal operating state Sc (step S103).

On the other hand, when determining that the alarm flag 15d is on in step S101 (step S101; Yes), the controller 11 allows the alarm 18 to output the alarm (step S104), allows the display 14 to display an alarm-in-action screen (step S105), and initiates an impact and stop operation monitoring process depicted in FIG. 8B (step S106). Thus, the mobile communication terminal 10 returns to the alarm state Sa. Subsequently, the controller 11 carries out the same processing as that in steps S17 to S25 in FIG. 8A.

On the other hand, when determining that the automatic notification flag 15c is on in step S102 (step S102; Yes), the controller 11 displays an out-of-order screen (step S107). Thus, the mobile communication terminal 10 returns to the background notification state Sb. Subsequently, the controller 11 carries out processing similar to that in steps S16 to S24 in FIG. 8A.

As described above, if the battery 20B is removed from the mobile communication terminal 10 in the alarm output state Sa, reloading of the battery 20B allows the mobile communication terminal 10 to return to the alarm output state Sa. If the battery 20B is removed from the mobile communication terminal 10 in the background notification state Sb, reloading of the battery 20B allows the mobile communication terminal 10 to return to the background notification state Sb. Thus, even if the perpetrator removes the battery 20B in order to stop the automatic notification and alarm, reloading of the battery 20B enables the last operation to be resumed.

As described above, when the perpetrator attempts to destroy the mobile communication terminal 10 according to Exemplary Embodiment 1, the mobile communication terminal 10 detects an impact exerted by the perpetrator and mimics a faulty state to suppress a further act of destruction. Furthermore, when the automatic notification is stopped by the removal of the battery 20B or the like, the automatic notification is resumed after restarting.

(Variation)

In the operation illustrated in FIG. 9, when the result of the determination in step S101 is Yes, the process is allowed to proceed to step S107. That is, the mobile communication terminal 10 is allowed to be set to the background notification state Sb when the battery 20B removed from the mobile communication terminal 10 in the alarm state Sa is reloaded in the mobile communication terminal 10. In this case, the controller 11 sets the alarm flag 15d off before starting step S108.

### Exemplary Embodiment 2

In Exemplary Embodiment 1, the mobile communication terminal 10 mimics a fault in the background notification state Sb but the manner of the mimicking is optional. A mobile communication terminal 10 will be described below which performs normal operations while continuing automatic notification in the background (so that the perpetrator fails to recognize the automatic notification).

Differences from Exemplary Embodiment 1 will be mainly described below. The same components of Exemplary Embodiment 2 as the corresponding components of Exemplary Embodiment 1 are denoted by the same reference numerals.

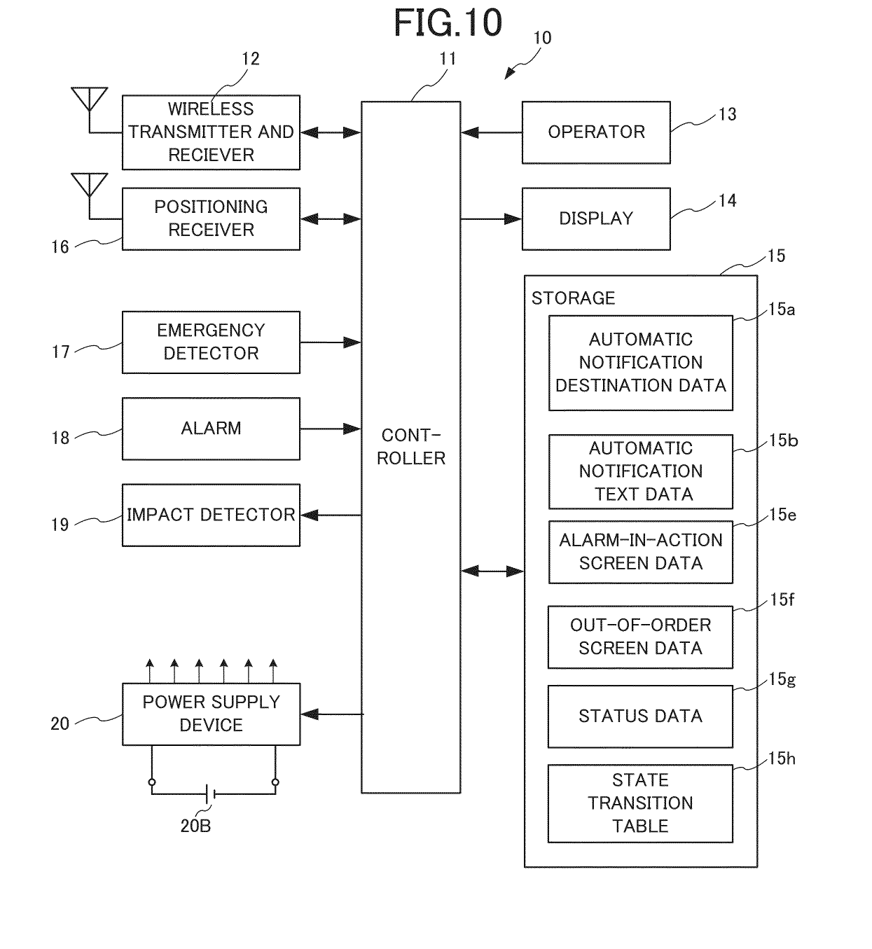

As depicted in FIG. 10, a storage 15 in the mobile communication terminal 10 according to Exemplary Embodiment 2 stores status data 15g and state transition table 15h. These data are stored in a nonvolatile portion of the storage 15.

The status data 15g is information indicative of the operating status of the mobile communication terminal 10. When the state of the mobile communication terminal 10 changes, the controller 11 updates the status data 15g. Furthermore, when the mobile communication terminal 10 is started, the controller 11 references the status data 15g to return to a state indicated by the status data 15g.

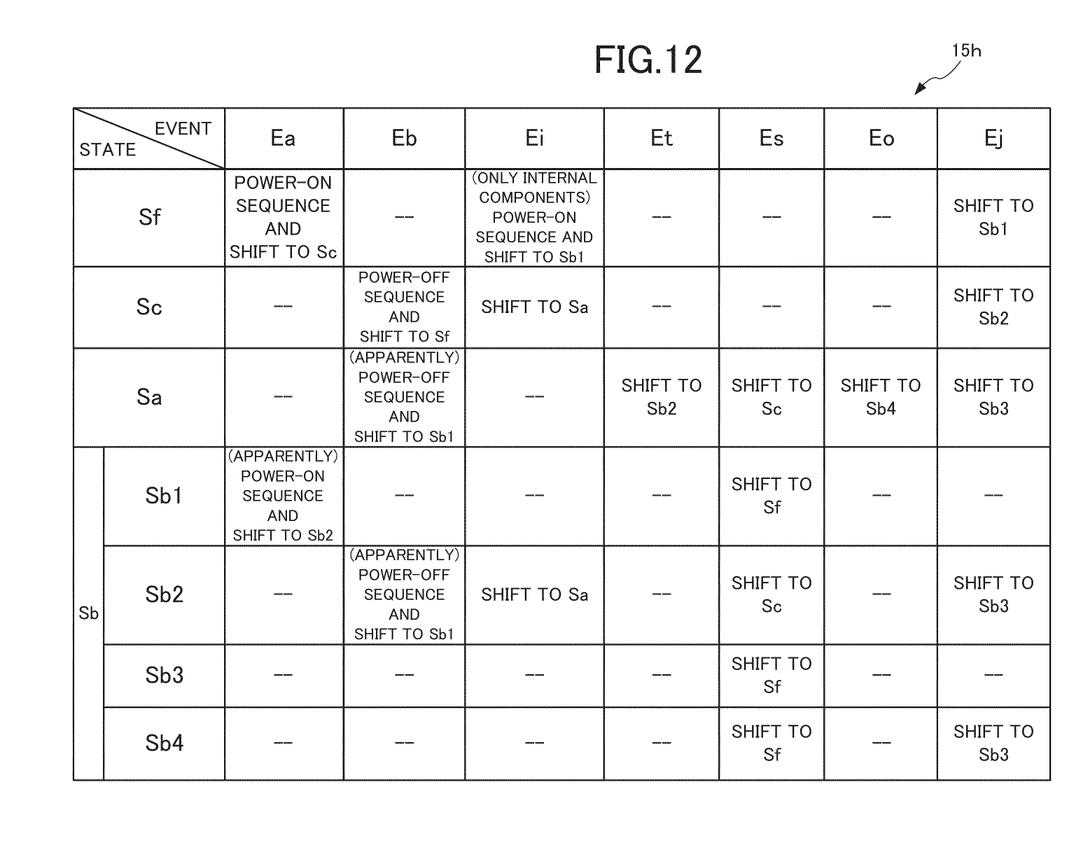

As depicted in FIG. 12, the state transition table 15h stores information indicating, for each state of the mobile communication terminal 10, which event shifts the mobile communication terminal 10 to which state, in an associated manner. Furthermore, the state transition table 15h stores information indicating what operation the mobile communication terminal 10 performs in association with the transition of the state.

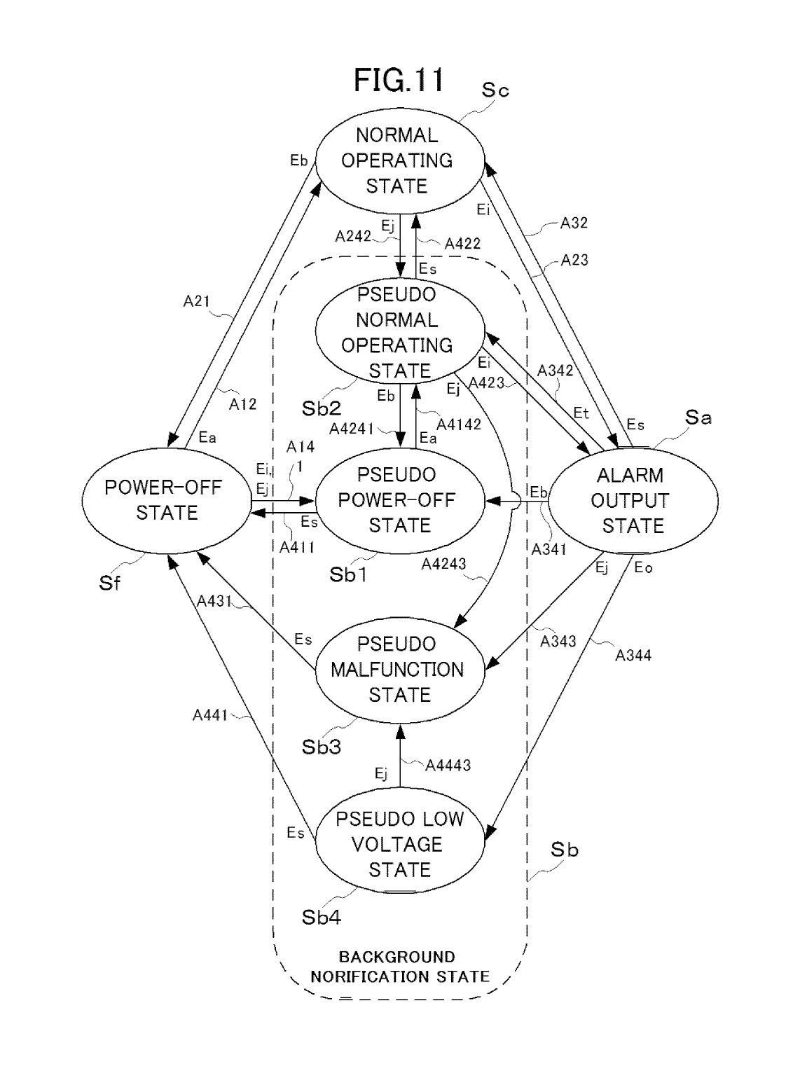

Now, operation of the mobile communication terminal 10 according to Exemplary Embodiment 2 will be described with reference to a state transition diagram depicted in FIG. 11.

The mobile communication terminal 10 includes a power-off state Sf, a normal operating state Sc, an alarm output state Sa, and a background notification state Sb. In the background notification state Sb according to Exemplary Embodiment 2, the controller 11 outputs an automatic alarm via a wireless transmitter and receiver 12, while an alarm 18 stops the alarm, with a display 14 providing a display similar to the display in another state.

The background notification state Sb includes a pseudo power-off state Sb1, a pseudo normal operating state Sb2, a pseudo malfunction state Sb3, and a pseudo low voltage state Sb4.

The pseudo power-off state Sb1 is a state in which the mobile communication terminal 10 is apparently in the power-off state Sf, but is performing the automatic notification. In this state, for example, the display 14 displays nothing, and an operator 13 accepts only a power-on operation.

The pseudo normal operating state Sb2 is a state in which the mobile communication terminal 10 apparently performs the same operation as that in the normal operating state Sc. While in the pseudo normal operating state Sb2, the mobile communication terminal 10 carries out processing such as a telephone call or transmission and reception of an e-mail according to the user's request, while performing the automatic notification in the background.

The pseudo malfunction state Sb3 is a state in which the mobile communication terminal 10 apparently performs an operation similar to the operation performed when the mobile communication terminal is faulty. The pseudo malfunction state is equal to the background notification state Sb according to Exemplary Embodiment 1.

The pseudo low voltage state Sb4 is a state in which the mobile communication terminal 10 apparently performs an operation similar to that in a low voltage mode. The low voltage mode is intended to save power by limiting the functions of the mobile communication terminal 10 when little power remains in the battery 20B. In the low voltage mode, the amount of light provided by the display 14 is reduced, and the frequency of an operation clock for a CPU is reduced.

The mobile communication terminal 10 shifts among the states according to the occurrence of predetermined events. The predetermined events as used herein refer to power-on operation detection Ea, power-off operation detection Eb, emergency detection Ei, impact detection Ej, notification stop operation detection Es, alarm stop attempt operation detection Et, and alarm time end Eo.

While the mobile communication terminal 10 is in the power-off state Sf, when the controller 11 detects a power-on operation (occurrence of the event “power-on operation detection Ea”), the mobile communication terminal 10 operates in accordance with a power-on sequence to shift to the normal operating state Sc as depicted by arrow A12. This allows the user to use the mobile communication terminal 10 for common applications such as telephone calls and transmission of e-mails.

Furthermore, while the mobile communication terminal 10 is in the power-off state Sf, when an emergency detector 17 detects the occurrence of an emergency situation (the occurrence of an event “detection Ei of the occurrence of an emergency situation”) or an impact detector 19 detects an impact equal to or higher than a threshold (the occurrence of an event “detection Ej of the occurrence of a strong impact”), the mobile communication terminal 10 starts internal components in accordance with the power-on sequence to shift to the pseudo power-off state Sb1, while apparently maintaining a display of a power-off state, as depicted by arrow A141. Furthermore, in conjunction with this state transition, the mobile communication terminal 10 starts the automatic notification.

While the mobile communication terminal 10 is in the normal operating state Sc, when the controller 11 detects a power-off operation (the occurrence of an event “power-off operation detection Eb”), the mobile communication terminal 10 operates in accordance with a power-off sequence to shift to the power-off state Sf as depicted by arrow A21.

While the mobile communication terminal 10 is in the normal operating state Sc, when the emergency detector 17 detects emergency detection (the occurrence of an event “emergency detection Ei”), the mobile communication terminal 10 shifts to the alarm output state Sa as depicted by arrow A23. In the alarm output state Sa, the mobile communication terminal 10 outputs the alarm and automatically transmits the notification.

Furthermore, while the mobile communication terminal 10 is in the normal operating state Sc, when the impact detector 19 detects an impact equal to or higher than a threshold (the occurrence of an event “impact detection Ej), the mobile communication terminal 10 shifts to the pseudo normal operating state Sb2 as depicted by arrow 242, and starts the automatic notification without outputting the alarm.

While the mobile communication terminal 10 is in the alarm output state Sa, when the controller 11 detects a power-off operation Eb (the occurrence of an event “power-off operation detection Eb”), the mobile communication terminal 10 allows the alarm 18 to stop the alarm, allows the display 14 to apparently provide the same display as that for the power-off sequence, and shifts to the pseudo power-off state Sb1 in accordance with arrow A341. Thus, the mobile communication terminal 10 continues the automatic notification while mimicking a power-off state.

While the mobile communication terminal 10 is in the alarm output state Sa, when the controller 11 detects an alarm stop attempt operation (the occurrence of an event “alarm stop attempt operation detection Et”), the mobile communication terminal 10 allows the alarm 18 to stop the alarm and shifts to the pseudo normal operating state Sb2 as depicted by arrow A342. Thus, the mobile communication terminal 10 continues the automatic notification while stopping the alarm and pretending to have returned to the normal operating state Sc. The alarm stop attempt operation as used herein refers to an operation considered to be performed by the perpetrator in an attempt to stop the alarm, for example, an operation of consecutively and randomly depressing keys on the operator 13 a predetermined number of times or more. The controller 11 determines whether an operation performed on the operator 13 corresponds to the alarm stop attempt operation based on a preset criterion. For example, the controller 11 determines that the alarm stop attempt operation has been performed when a preset false password is input to a predetermined password input screen. Alternatively, the controller 11 determines that the alarm stop attempt operation has been performed when 4 to 12 characters have consecutively been input.

While the mobile communication terminal 10 is in the alarm output state Sa, when the controller 11 detects a notification stop operation (the occurrence of an event “notification stop operation detection Es), the mobile communication terminal 10 stops the alarm and the automatic notification and shifts to the normal operating state Sc as depicted by arrow A32.

When the mobile communication terminal 10 shifts to the alarm output state Sa, the controller 11 starts clocking. Subsequently, when the controller 11 detects that a clocking time (the time having elapsed since the start of output of an alarm by the alarm 18) has reached a predetermined alarm time (the occurrence of an event “alarm time end Eo”), the mobile communication terminal 10 allows the alarm 18 to stop the alarm and shifts to the pseudo low voltage state Sb4 as depicted by arrow A344. Thus, the mobile communication terminal 10 stops the alarm and continues the automatic notification while mimicking the low voltage state.

While the mobile communication terminal 10 is in the alarm output state Sa, when the impact detector 19 detects an impact (the occurrence of an event “impact detection Ej”), the mobile communication terminal 10 allows the alarm 18 to stop the alarm and shifts to the pseudo malfunction state Sb3 as depicted by arrow A343. Thus, the mobile communication terminal 10 continues the automatic notification while mimicking a fault.

While the mobile communication terminal 10 is in the pseudo power-off state Sb1, when a power-on operation Ea is detected (the occurrence of an event “power-on operation detection Ea”), the mobile communication terminal 10 apparently provides a display similar to the display for the power-on sequence, and shifts to the pseudo normal operating state Sb2 as depicted by arrow A4142.

While the mobile communication terminal 10 is in the pseudo power-off state Sb1, when a notification stop operation is detected (the occurrence of an event “notification stop operation detection Es”), the mobile communication terminal 10 shifts to the power-off state Sf in accordance with the power-off sequence as depicted by arrow A411.

While the mobile communication terminal 10 is in the pseudo normal operating state Sb2, when a power-off operation Eb is detected (the occurrence of an event “power-off operation detection Eb”), the mobile communication terminal 10 apparently provides a display similar to the display for the power-off sequence, and shifts to the pseudo power-off state Sb1 as depicted by arrow A4241. Furthermore, while the mobile communication terminal 10 is in the pseudo normal operating state Sb2, when the emergency detector 17 detects occurrence of an emergency situation (the occurrence of an event “emergency detection Ei”), the mobile communication terminal 10 outputs an alarm while continuing the automatic notification, and shifts to the alarm output state Sa as depicted by arrow A423. Additionally, while the mobile communication terminal 10 is in the pseudo normal operating state Sb2, when a notification stop operation is detected (the occurrence of an event “notification stop operation detection Es”), the mobile communication terminal 10 stops the automatic notification, and shifts to the normal operating state Sc as depicted by arrow A422. In addition, while the mobile communication terminal 10 is in the pseudo normal operating state Sb2, when an impact equal to or higher than a threshold (the occurrence of an event “impact detection Ej”), the mobile communication terminal 10 provides a display similar to the display for a fault, and shifts to the pseudo malfunction state Sb3 as depicted by arrow A4243.

While the mobile communication terminal 10 is in the pseudo malfunction state Sb3, when a notification stop operation is detected (the occurrence of an event “notification stop operation detection Es”), the mobile communication terminal 10 stops the automatic notification, and shifts to the power-off state Sf as depicted by arrow A431.

While the mobile communication terminal 10 is in the pseudo low voltage state Sb4, when a notification stop operation is detected (the occurrence of an event “notification stop operation detection Es”), the mobile communication terminal 10 stops the automatic notification, and shifts to the power-off state Sf as depicted by arrow A441. Furthermore, while the mobile communication terminal 10 is in the pseudo low voltage state Sb4, when an impact equal to or higher than the threshold is detected (the occurrence of an event “impact detection Ej”), the mobile communication terminal 10 provides a display similar to the display for a fault, and shifts to the pseudo malfunction state Sb3 as depicted by arrow A4443.

When the mobile communication terminal 10 shifts the state thereof, the controller 11 references the state transition table 15h to shift the state of the mobile communication terminal 10 in accordance with the contents of the state transition table 15h. As depicted in FIG. 12, the state transition table 15d stores the current state of the mobile communication terminal 10, an operation performed when a predetermined event occurs in the current state, and a state to which the current state is to be shifted, in association with one another.

By shifting among the plurality of states as described above, the mobile communication terminal 10 starts and stops the alarm and the automatic notification according to the user's operation and the situation.

When shifting the state in accordance with the state transition table 15h, the controller 11 stores status data 15g indicative of the shifted state in the storage 15. Furthermore, when starting the mobile communication terminal 10 provided with a battery 20B, the controller 11 references the status data 15g to return to the stored state. Thus, when the mobile communication terminal is in the alarm output state Sa before the battery 20B is removed from the mobile communication terminal 10, the controller 11 resumes the output of the alarm and the automatic notification. When the mobile communication terminal is in the background notification state Sb before the battery 20B is removed from the mobile communication terminal 10, the controller 11 resumes the automatic notification.

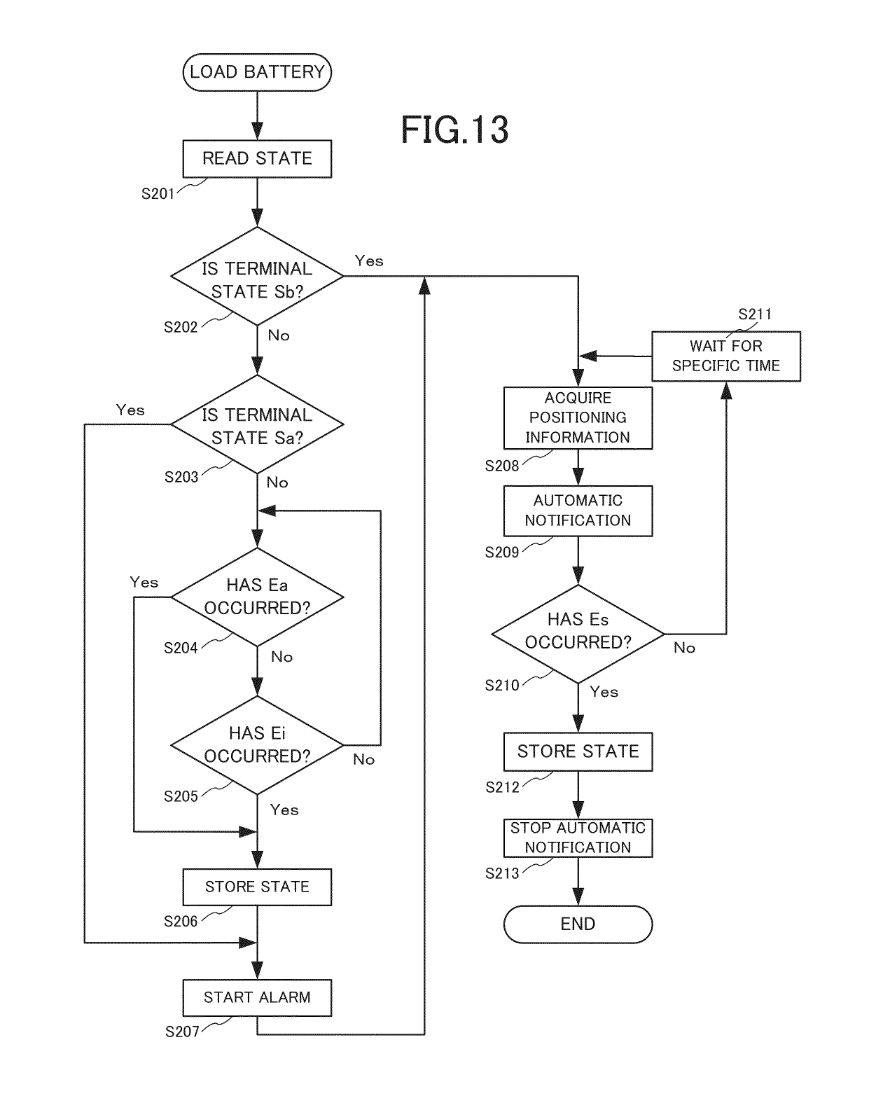

Now, the operation of the mobile communication terminal 10 provided with the battery 20B will be described with reference to FIG. 13.

When the battery 20B is loaded in the mobile communication terminal 10, the controller 11 reads the status data 15g (step S201). The controller 11 determines whether or not the read status is indicative of the background notification state Sb (one of the pseudo power-off state Sb1, the pseudo normal operating state Sb2, the pseudo malfunction state Sb3, and the pseudo low voltage state Sb4) (step S202). If the status is indicative of the background notification state Sb (step S202; Yes), the controller 11 shifts the mobile communication terminal 10 to the stored state and passes the processing to step S208.

If the status is not indicative of the background notification state Sb (step S202; No), the controller 11 determines whether the read state is the alarm output state Sa (step S203). If the read status is indicative of the alarm output state Sa (step S203; Yes), the controller 11 shifts the mobile communication terminal 10 to the alarm output state Sa and passes the processing to step S207.

If the read state is not indicative of the alarm output state Sa (step S203; No), the controller 11 operates in accordance with the read status (power-off state Sf or normal operating state Sc). That is, if the read status is indicative of the power-off state Sf, the main portion is powered off, and a limited operation such as a power-on operation is accepted. If the read status is indicative of the normal operating state Sc, common operations by the user (telephone calls, transmission of e-mails, and the like) are accepted as usual. In parallel, the controller 11 determines whether or not the emergency detection Ei has occurred (step S204) and whether or not the impact detection Ej has occurred (step S205). If neither of the detections has occurred (step S204; No and step S205; No), the controller 11 returns to step S204 to repeatedly determine whether or not the emergency detection Ei has occurred and whether or not the impact detection Ej has occurred.

If, in step S204, the emergency detection Ei is determined to have occurred (step S204; Yes), or in step S205, the impact detection Ej is determined to have occurred (step S205; Yes), the controller 11 shifts the mobile communication terminal 10 to the alarm output state Sa and stores status data 15g indicative of the shifted state in the storage 15 (step S206).

The controller 11 allows the alarm 18 to generate an alarm (step S207).

Subsequently, the controller 11 acquires positioning information from a positioning information receiver 16 (step S208). The controller 11 uses the positioning information to carry out the automatic notification (step S209).

Then, the controller 11 determines whether or not a notification stop operation has been detected (step S210). If no notification stop operation has been detected (step S210; No), the controller 11 waits for a specific time (step S211) and repeats the acquisition of positioning information and the automatic notification. During steps S208 to S210, if the mobile communication terminal 10 is in the pseudo normal operating state Sb2, the user is able to perform operations for telephone calls, e-mails, and the like using the mobile communication terminal 10.

If, in step S10, a notification stop operation is determined to have been detected (step S210; Yes), the controller 11 shifts the mobile communication terminal 10 to the normal operating state Sc or the power-off state Sf and stores status data 15g indicative of the shifted state in the storage 15 (step S212). The controller 11 then allows the alarm 18 to stop the alarm (step S213).

When step S213 is completed, the mobile communication terminal 10 ends the process following the starting based on the loading of the battery 20B. When the process ends, the mobile communication terminal 10 is in the power-off state Sf or the normal operating state Sc. If the mobile communication terminal 10 is in the normal operating state Sc, the mobile communication terminal 10 subsequently provides the normal functions (telephone calls, transmission and reception of e-mails, and the like) for the user until the power-off operation detection Eb, the emergency detection Ei, or the impact detection Ej occurs. If the mobile communication terminal 10 is in the power-off state Sf, the mobile communication terminal 10 subsequently remains in the power-off state Sf until the power-on operation detection Ea, the emergency detection Ei, or the impact detection Ej occurs.

In the background notification state Sb, the mobile communication terminal 10 shifts among the pseudo power-off state Sb1, the pseudo normal operating state Sb2, the pseudo malfunction state Sb3, and the pseudo low voltage state Sb4 while apparently keeping the automatic notification stopped. That is, the mobile communication terminal 10 in the background notification state Sb apparently performs an operation similar to the operation in the normal state, while carrying out the automatic notification in the background. Thus, the mobile communication terminal 10 is able to continue the automatic notification while dealing with a variety of situations where, for example, the perpetrator attempts to destroy the mobile communication terminal 10, to stop the alarm, or to use the mobile communication terminal 10.

When the state of the mobile communication terminal 10 is shifted, the controller 11 stores, in the storage 15, status data 15g indicative of the state to which the current state is to be shifted. Thus, even if the battery in the mobile communication terminal 10 is exhausted or removed, the mobile communication terminal 10 is able to continue the operation corresponding to the state after being restarted.

As described above, the mobile communication terminal 10 according to Exemplary Embodiment 2 mimics a faulty state to suppress a further act of destruction when the perpetrator exerts an impact on the mobile communication terminal 10. Furthermore, if the battery 20B is removed from the mobile communication terminal 10 to stop the automatic notification, the mobile communication terminal 10 resumes the automatic notification after being restarted. Additionally, the mobile communication terminal 10 according to Exemplary Embodiment 2 is able to apparently perform an operation similar to the operation in the normal state while continuing the automatic notification in the background. Thus, after an emergency situation occurs, the mobile communication terminal 10 allows operations for telephone calls, transmission and reception of e-mails, and the like to be performed as usual while continuing the automatic notification.

(Variation)

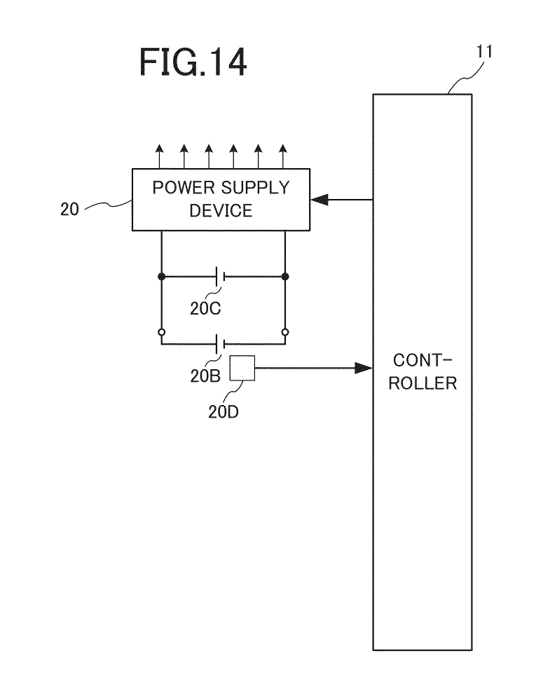

As depicted in FIG. 14, the power supply device 20 is allowed to include an unremovable electric energy retaining device (battery or capacitor) 20C besides the removable battery 20B. The electric energy retaining device 20C retains electric energy. The electric energy retaining device 20C has a capacity enough to allow the mobile communication terminal 10 to operate (automatic notification) in the background notification state Sb for a specific period (for example, one hour).

The power supply device 20 supplies power to the components of the mobile communication terminal 10 while being supplied with energy by the electric energy retaining device 20C even after the battery 20B is removed. When a removal sensor 20D detects the removal of the battery 20B, the controller 11 shifts the mobile communication terminal 10 to the background notification state Sb and further turns the display provided by the display 14 off according to Exemplary Embodiment 1. Furthermore, according to Exemplary Embodiment 2, the mobile communication terminal 10 is shifted to the pseudo power-off state Sb1.

Exemplary Embodiments 1 and 2 have been described, but the present invention is not limited to the above-described embodiments.

For example, the positioning information receiver 16 is allowed to be omitted from the mobile communication terminal 10 according to the above-described exemplary embodiments. In this case, the mobile communication terminal 10 is allowed to acquire positional information using base station positioning implemented through the cooperation of the controller 11, the wireless transmitter and receiver 12, and the mobile communication network 20 instead of the positioning function of the positioning information receiver 16.

For example, the emergency detector 17 of the mobile communication terminal according to the above-described exemplary embodiments is allowed to be omitted. That is, the emergency detection Ei is allowed to involve performing a predetermined operation using the operator 13. The emergency detection Ei is allowed to involve reception of a predetermined signal by the controller 11 via the wireless transmitter and receiver 12. Moreover, the emergency detection Ei is, for example, an operation in which the positional information receiver 16 and the controller 11 cooperate in determining that the position of the mobile communication terminal 10 falls within a predetermined range (or out of the predetermined range).

For example, the alarm 18 is allowed to be omitted from the mobile communication terminal according to the above-described exemplary embodiments, thus providing a mobile communication terminal with only the automatic notification function as a crime prevention function. That is, the alarm output state Sa is allowed to involve carrying out the automatic notification while allowing the display 14 to indicate that the automatic notification function is active.

For example, according to the above-described exemplary embodiments, the wireless transmitter and receiver 12 is connected to the mobile communication network but is allowed to be connected to a communication network other than the mobile communication network, via wireless LAN, Bluetooth, infrared communication, or the like.

For example, in the above-described exemplary embodiments, the controller 11 uses notification from the impact detector 19 simply as a trigger to a state transition. However, the controller 11 is allowed to store information on an impact detected by the impact detector 19 in the storage 15. The information on the impact includes the intensity of the impact, the time of detection of the impact, or the place of detection of the impact which is combined with positioning information. The controller 11 is allowed to add these pieces of information to a message transmitted by the automatic notification.

For example, in the above-described exemplary embodiments, the transmitted automatic notification is not limited to the e-mail, and the message is allowed to be transmitted utilizing SMS (Short Message Service) or the like. If the mobile communication terminal 10 includes a telephone call function, the automatic notification is allowed to be carried out by automatically reproducing a voice message.

For example, in the above-described exemplary embodiments, the positioning information added to the notification message is allowed to be simply indicative of latitude and longitude or to be positional information determined by the controller 11 in accordance with a predetermined program. The controller 11 is allowed to store positioning information received by the positioning information receiver 16 in the storage 15 and to add history of accumulated positioning information or the like to the notification message.

For example, in the above-described exemplary embodiments, the controller 11 repeats the automatic notification every specific time but the automatic notification need not be carried out at intervals of a specific time. The controller 11 is allowed to, for example, carry out the automatic notification at intervals of 10 minutes when much power remains in the battery and at intervals of one hour when little power remains in the battery. If the mobile communication terminal is located out of the service area, the controller 11 is allowed to carry out the automatic notification at intervals of one hour in order to reduce consumed power and to carry out the automatic notification at intervals of 10 minutes after the mobile communication terminal enters the service area. This reduces power consumption to enable the automatic notification to be continued for a long period.

For example, the functions of the mobile communication terminal according to the above-described exemplary embodiments have been described taking only the transmission and reception of e-mails, the alarm, and the automatic notification as examples. However, the mobile communication terminal is allowed to be additionally provided with components implementing functions such as telephone calls, a camera, a television, navigation, and reproduction of music and moving images. Utility software for a notepad, schedule management, and the like and game and other applications are allowed to be stored in the storage 15 as programs.

For example, the state transition table 15d according to Exemplary Embodiment 2 is allowed to be configured such that the contents of the table are edited by the user. This allows the user to optionally change the operation of the mobile communication terminal 10. For example, the mobile communication terminal 10 is allowed to be reset such that regardless of the state of the mobile communication terminal 10, the mobile communication terminal 10 shifts to the pseudo malfunction state Sb3 whenever the impact detection Ej occurs.

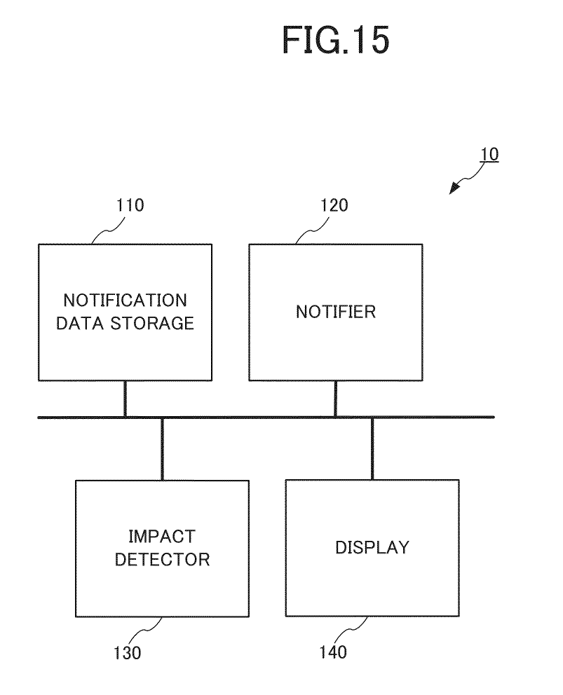

Moreover, as depicted in FIG. 15, the mobile communication terminal 10 according to the exemplary embodiments is allowed to include a notification data storage 110, a notifier 120, an impact detector 130, and a display 140.

The notification data storage 110 stores a notification destination. The notifier 120 transmits notification to the notification destination stored in the notification data storage 110. The impact detector 130 detects exertion of an impact equal to or higher than a threshold. The display 140 displays information for the user. If the impact detector 130 detects exertion of an impact equal to or higher than the threshold while the notifier 120 is transmitting the notification to the notification destination, the display 140 displays a screen representing a state where the notification by the notifier 120 is stopped.

Such a configuration also achieves the exemplary objects of the present invention and exerts the exemplary effects of the present invention.

The functions of the mobile communication terminal according to the above-described exemplary embodiments are allowed to be implemented by dedicated hardware or a common computer system.

For example, an apparatus that carries out the above-described process is able to be configured by storing the program stored in the storage 15 of the mobile communication terminal according to the exemplary embodiments in a computer readable recording medium such as a flexible disk, a CD-ROM (Compact Disk Read-Only Memory), a DVD (Digital Versatile Disk), or an MO (Magneto-Optical disk), distributing the recording medium, and installing the program in a computer.

The program is allowed to be stored in a disk device or the like of a predetermined server apparatus on a communication network such as the Internet, and for example, to be superimposed on a carrier and downloaded into the computer.

The above-described process is also able to be achieved by initiating and executing the program transferred via the communication network.

The above-described process is also able to be achieved by executing all or a part of the program on the server apparatus and executing the program while transmitting and receiving information for the processing by the computer via the communication network.

For example, when the above-described functions are implemented by an OS (Operating System) in a shared manner or through cooperation between the OS and relevant applications, only the components other than the OS are allowed to be stored in the medium for distribution and to be downloaded into the computer.

Various exemplary embodiments and variations of the present invention are possible without departing from the spirits and scope of the present invention in a broad sense. Furthermore, the above-described exemplary embodiments are intended to describe the present invention and not to limit the scope thereof. That is, the scope of the present invention is not indicated by the exemplary embodiments but by the claims. Variations made within the scope of the claims and within the scope of the significance of the invention equivalent to the scope of the claims are considered to be within the scope of the present invention.

The whole or part of the exemplary embodiments disclosed above can be described as, but not limited to, the following supplementary notes.

(Supplementary Note 1)

A mobile communication terminal including:

a notifier that transmits notification to a preset notification destination;

an impact detector that detects an impact exerted on the mobile communication terminal;

a display; and

a controller that displays, on the display, a screen representing a state in which the notification by the notifier is stopped when the impact detector detects an impact while the notifier is transmitting notification to the notification destination.

(Supplementary Note 2)

The mobile communication terminal according to Appendix 1, wherein the controller causes the display to display a screen substantially identical to a screen displayed when the mobile communication terminal is faulty, when the impact detector detects an impact.

(Supplementary Note 3)

The mobile communication terminal according to Appendix 1, further including a state storage that stores state data indicating whether or not the mobile communication terminal is in a state in which the notifier is transmitting the notification,

wherein, when the mobile communication terminal is powered on, the notifier starts transmitting the notification to the notification destination if the data indicating that the mobile communication terminal is in a state in which the notifier is transmitting the notification is stored in the state storage.

(Supplementary Note 4)

The mobile communication terminal according to Appendix 1, wherein the controller causes the notifier to start transmitting the notification to the notification destination when the impact detector detects the impact or when a predetermined operation is performed.

(Supplementary Note 5)

The mobile communication terminal according to Appendix 1, including an alarm that outputs an alarm,

wherein the controller causes the alarm to output an alarm and causes the notifier to transmit the notification, when detecting a predetermined operation or when the impact detector detects the impact in a power-off state in which the mobile communication terminal is powered off or in a normal operating state in which the mobile communication terminal is operating normally, and

causes the alarm to stop the alarm, causes the display to display an image indicating that the mobile communication terminal is faulty, and causes the notifier to continue the notification when the impact detector detects the impact while the alarm is outputting the alarm.

(Supplementary Note 6)

The mobile communication terminal according to Appendix 1, wherein the controller causes the notifier to start the notification and prevents the display from indicating that the notification is being transmitted to shift the mobile communication terminal to a pseudo normal operating state when the impact detector detects the impact while the mobile communication terminal is in a normal operating state in which the mobile communication terminal is operating normally.

(Supplementary Note 7)

The mobile communication terminal according to Appendix 6, wherein, when detecting a power-off operation while the mobile communication terminal is in the pseudo normal operating state,

the controller causes the display to be turned off and causes the notifier to continue the notification to shift the mobile communication terminal to a pseudo power-off state in which the mobile communication terminal is apparently powered off with the notification continued.

(Supplementary Note 8)

The mobile communication terminal according to Appendix 7, further including an alarm,

wherein the controller causes the alarm to output an alarm and causes the notifier to continue the notification to shift the mobile communication terminal to an alarm output state when detecting execution of a predetermined operation while the mobile communication terminal is in the pseudo normal operating state.

(Supplementary Note 9)

The mobile communication terminal according to Appendix 6, wherein the controller causes the notifier to continue the notification and causes the display to display an image indicating that the mobile communication terminal is faulty to shift the mobile communication terminal to a pseudo malfunction state when the impact detector detects the impact while the mobile communication terminal is in the pseudo normal operating state.

(Supplementary Note 10)

The mobile communication terminal according to Appendix 1, wherein the controller causes the notifier to start the notification with the display keeping turned off to shift the mobile communication terminal to the pseudo power-off state when the impact detector detects the impact or when execution of a predetermined operation indicating occurrence of an emergency situation is detected while the mobile communication terminal is in the power-off state.

(Supplementary Note 11)

The mobile communication terminal according to Appendix 10, wherein the controller causes the display to display an image identical to an image displayed in a normal state and causes the notifier to continue the notification to shift the mobile communication terminal to the pseudo normal operating state when a power-on operation is performed while the mobile communication terminal is in the pseudo power-off state.

(Supplementary Note 12)

The mobile communication terminal according to Appendix 11, wherein the controller causes the notifier to stop the notification to shift the mobile communication terminal to the power-off state when detecting execution of an operation of giving an instruction to stop the notification while the mobile communication terminal is in the pseudo power-off state.

(Supplementary Note 13)

The mobile communication terminal according to Appendix 12, wherein the controller causes the display to turn off the display and causes the notifier to continue the notification to shift the mobile communication terminal to the pseudo power-off state in which the mobile communication terminal is apparently powered off, when detecting execution of an operation of turning off the mobile communication terminal in the alarm output state in which the alarm outputs the alarm, with the notifier transmitting the notification.

(Supplementary Note 14)

The mobile communication terminal according to Appendix 8, wherein, while the alarm is outputting the alarm, the controller:

causes the alarm to stop the alarm and causes the notifier to stop the notification to shift the mobile communication terminal to the normal operating state when a predetermined first operation is performed to stop the alarm, and

causes the alarm to stop the alarm, causes the notifier to continue the notification, and prevents the display from presenting that the notification is being transmitted to shift the mobile communication terminal to the pseudo normal operating state when a second operation different from the first operation is performed.

(Supplementary Note 15)

The mobile communication terminal according to Appendix 8, wherein, when the alarm continues to output the alarm for a specific period,

the controller causes the alarm to stop the alarm, causes the display to provide a display equivalent to a display provided when a power supply voltage decreases below a reference level, and causes the notifier to continue the notification to shift the mobile communication terminal to a pseudo low voltage state.

(Supplementary Note 16)

The mobile communication terminal according to Appendix 3, including a power supply device that supplies an operating power to the notifier, the display, and the controller,

wherein the power supply device includes a removable battery and an unremovable electric energy retaining device.

(Supplementary Note 17)

The mobile communication terminal according to Appendix 15, wherein the controller causes the display to display an image representing a fault and causes the notifier to continue the notification to shift the mobile communication terminal to the pseudo malfunction state when the impact detector detects an impact in the pseudo low voltage state or when the impact detector detects an impact in the alarm output state.

(Supplementary Note 18)

A crime prevention method including:

a notification step of transmitting notification to a preset notification destination;

an impact detection step of detecting an impact exerted on the mobile communication terminal; and

a step of displaying a screen indicating that the notification is stopped with the notification in the notification step maintained when exertion of an impact is detected in the impact detection step during the notification in the notification step.

(Supplementary Note 19)

A computer-readable recording medium recording a program thereon which causes a computer to execute:

a notification step of transmitting notification to a preset notification destination;

an impact detection step of detecting an impact exerted on the mobile communication terminal; and

a step of displaying a screen indicating that the notification is stopped with the notification in the notification step maintained when exertion of an impact is detected in the impact detection step during the notification in the notification step.

Having described and illustrated the principles of this application by reference to one or more preferred embodiments, it should be apparent that the preferred embodiments may be modified in arrangement and detail without departing from the principles disclosed herein and that it is intended that the application be construed as including all such modifications and variations insofar as they come within the spirit and scope of the subject matter disclosed herein.

What is claimed is:

1. A mobile communication terminal comprising:
a notifier that transmits notification to a preset notification destination;
an impact detector that detects an impact exerted on the mobile communication terminal;
a display; and
a controller that displays, on the display, a screen representing a state in which the notification by the notifier is stopped when the impact detector detects an impact while the notifier is transmitting notification to the notification destination.

2. The mobile communication terminal according to claim 1, wherein the controller causes the display to display a screen substantially identical to a screen displayed when the mobile communication terminal is faulty, when the impact detector detects an impact.

3. The mobile communication terminal according to claim 1, further comprising a state storage that stores state data indicating whether or not the mobile communication terminal is in a state in which the notifier is transmitting the notification,
wherein, when the mobile communication terminal is powered on, the notifier starts transmitting the notification to the notification destination if the data indicating that the mobile communication terminal is in a state in which the notifier is transmitting the notification is stored in the state storage.

4. The mobile communication terminal according to claim 1, wherein the controller causes the notifier to start transmitting the notification to the notification destination when the impact detector detects the impact or when a predetermined operation is performed.

5. The mobile communication terminal according to claim 1, comprising an alarm that outputs an alarm,
wherein the controller causes the alarm to output an alarm and causes the notifier to transmit the notification, when detecting a predetermined operation or when the impact detector detects the impact in a power-off state in which the mobile communication terminal is powered off or in a normal operating state in which the mobile communication terminal is operating normally, and
causes the alarm to stop the alarm, causes the display to display an image indicating that the mobile communication terminal is faulty, and causes the notifier to continue the notification when the impact detector detects the impact while the alarm is outputting the alarm.

6. The mobile communication terminal according to claim 1, wherein the controller causes the notifier to start the notification and prevents the display from indicating that the notification is being transmitted to shift the mobile communication terminal to a pseudo normal operating state when the impact detector detects the impact while the mobile communication terminal is in a normal operating state in which the mobile communication terminal is operating normally.

7. The mobile communication terminal according to claim 6, wherein the controller causes the display to be turned off and allows the notifier to continue the notification to shift the mobile communication terminal to a pseudo power-off state in which the mobile communication terminal is apparently powered off with the notification continued, when detecting a power-off operation while the mobile communication terminal is in the pseudo normal operating state.

8. The mobile communication terminal according to claim 7, further comprising an alarm,
wherein the controller causes the alarm to output an alarm and causes the notifier to continue the notification to shift the mobile communication terminal to an alarm output state when detecting execution of a predetermined operation while the mobile communication terminal is in the pseudo normal operating state.

9. The mobile communication terminal according to claim 6, wherein the controller causes the notifier to continue the notification and causes the display to display an image indicating that the mobile communication terminal is faulty to shift the mobile communication terminal to a pseudo malfunction state when the impact detector detects the impact while the mobile communication terminal is in the pseudo normal operating state.

10. The mobile communication terminal according to claim 1, wherein the controller causes the notifier to start the notification with the display keeping turned off to shift the mobile communication terminal to the pseudo power-off state when the impact detector detects the impact or when execution of a predetermined operation indicating occurrence of an emergency situation is detected while the mobile communication terminal is in the power-off state.

11. The mobile communication terminal according to claim 10, wherein the controller causes the display to display an image identical to an image displayed in a normal state and causes the notifier to continue the notification to shift the mobile communication terminal to the pseudo normal operating state when a power-on operation is performed while the mobile communication terminal is in the pseudo power-off state.

12. The mobile communication terminal according to claim 11, wherein the controller causes the notifier to stop the notification to shift the mobile communication terminal to the power-off state when detecting execution of an operation of giving an instruction to stop the notification while the mobile communication terminal is in the pseudo power-off state.

13. The mobile communication terminal according to claim 12, wherein the controller causes the display to turn off the display and causes the notifier to continue the notification to shift the mobile communication terminal to the pseudo power-off state in which the mobile communication terminal is apparently powered off, when detecting execution of an operation of turning off the mobile communication terminal in the alarm output state in which the alarm outputs the alarm, with the notifier transmitting the notification.

14. The mobile communication terminal according to claim 8, wherein, while the alarm is outputting the alarm, the controller:
causes the alarm to stop the alarm and causes the notifier to stop the notification to shift the mobile communication terminal to the normal operating state when a predetermined first operation is performed to stop the alarm, and
causes the alarm to stop the alarm, causes the notifier to continue the notification, and prevents the display from presenting that the notification is being transmitted to shift the mobile communication terminal to the pseudo normal operating state when a second operation different from the first operation is performed.

15. The mobile communication terminal according to claim 8, wherein the controller causes the alarm to stop the alarm, causes the display to provide a display equivalent to a display provided when a power supply voltage decreases below a reference level, and causes the notifier to continue the notification to shift the mobile communication terminal to a pseudo low voltage state when the alarm continues to output the alarm for a specific period.

16. The mobile communication terminal according to claim 3, comprising a power supply device that supplies an operating power to the notifier, the display, and the controller,
wherein the power supply device comprises a removable battery and an unremovable electric energy retaining device.

17. The mobile communication terminal according to claim 15, wherein the controller causes the display to display an image representing a fault and causes the notifier to continue the notification to shift the mobile communication terminal to the pseudo malfunction state when the impact detector detects an impact in the pseudo low voltage state or when the impact detector detects an impact in the alarm output state.

18. A crime prevention method comprising:
a notification step of transmitting notification to a preset notification destination;
an impact detection step of detecting an impact exerted on the mobile communication terminal; and
a step of displaying a screen indicating that the notification is stopped with the notification in the notification step maintained when exertion of an impact is detected in the impact detection step during the notification in the notification step.

19. A computer-readable recording medium recording a program thereon, the program causing a computer to execute:
a notification step of transmitting notification to a preset notification destination;
an impact detection step of detecting an impact exerted on the mobile communication terminal; and
a step of displaying a screen indicating that the notification is stopped with the notification in the notification step maintained when exertion of an impact is detected in the impact detection step during the notification in the notification step.
